(19) United States
(12) Patent Application Publication
(10) Pub. No.: US 2005/0243245 A1
(43) Pub. Date: Nov. 3, 2005

(54) Polarizing plate and production process of the same

(75) Inventors: Keiichi Taguchi, Minami-ashigara-shi (JP); Kentaro Shiratuchi, Fujinomiya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/071,158

(22) Filed: Mar. 4, 2005

(30) Foreign Application Priority Data
Mar. 4, 2004 (JP) 2004-060098
Sep. 24, 2004 (JP) 2004-276546

(51) Int. Cl. G02F 1/1335

(52) U.S. Cl. 349/96

(57) ABSTRACT

A novel polarizing plate is disclosed. The polarizing plate comprises a polyvinyl alcohol based polarizer, a protective film comprising a saturated alicyclic structure-containing thermoplastic polymer, and an adhesive layer comprising a water-soluble polymer between the protective film and the polarizer wherein the surface of the protective film contacting with the adhesive layer is subjected to a surface treatment.

### CROSS-REFERENCE TO RELATED APPLICATIONS

This application claims benefit of priority under 35 USC 119 to Japanese Patent Application No. 2004-276546 filed Sep. 24, 2004 and Japanese Patent Application No. 2004-060098 filed Mar. 4, 2004.

### TECHNICAL FIELD

The present invention relates to a polarizing plate which is suitably used for liquid crystal display devices and has excellent durability and to a production process of the same.

### RELATED ART

A polarizing plate is a main member such that one sheet or two sheets thereof are laminated on a module of a liquid crystal display device (hereinafter “LCD”), thereby determining a characteristic of transmitted light and non-transmitted light, and its degree of importance in the polarizing plate industry is increasing with an expansion of the LCD market scale. In general, a polarizing plate is based on a construction in which a protective film is laminated on the both surfaces or one surface of an absorption type polarizer having a function to convert transmitted light into linearly polarized light using an adhesive, and for the purpose of further laminating the protective film with a protective film or laminating it with a liquid crystal module, the polarizing plate is shipped in the state that an adhesive layer or a separator film is laminated thereon and used in the LCD industry.

A polarizer is made of iodine and/or a dichroic dye, boric acid, and polyvinyl alcohol (hereinafter “PVA”) as major raw materials. By highly aligning iodine and/or a dichroic dye, absorption dichroism is developed, whereby it becomes possible to convert the transmitted light into linearly polarized light. PVA functions as a medium of the highly aligned iodine and/or dichroic dye and is aligned by stretching in the same direction as the iodine and/or dichroic dye. Boric acid crosslinks PVA, thereby bearing a function to stabilize the alignment state of PVA and also the alignment state of the iodine and/or dichroic dye.

When a polarizer is used for a long time, shrinkage causes in the polarizer, and, thus, color unevenness or color deletion due to the shrinkage occurs. In recent years, such color unevenness or color deletion becomes a bigger problem with an enlargement of the size of a liquid crystal display device. For the purpose of reducing the color unevenness or color deletion in a large-scale liquid crystal display device, there is proposed that an alicyclic structure-containing polymer is used for a protective film (for example, JPA No. 2002-90546, the term “JPA” as used herein means an “unexamined published Japanese patent application (Kohkai Tokkyo Kohou)”). However, the protective film formed of the alicyclic structure-containing polymer is not easily laminated on a polarize. In order to solve this problem, there are proposed a method of performing a surface activation treatment such that the surface free energy is 50 dyne/cm or more and 72 dyne/cm or less and providing one or more hydrophilic layers (JPA No. hei 9-127332); a method of performing an ultraviolet irradiation treatment such that the surface wet index is 40 dyne/cm or more (JPA No. 2000-266932); a method of using a polyurethane resin layer as an adhesive layer (JPA No. 2001-174637); a method of laminating a resin layer containing polyvinyl alcohol and polyethyleneimine on an alicyclic structure-containing polymer film (JPA No. 2001-272535); a method of providing a water-absorbing layer between a polymer sheet layer and a water-soluble adhesive layer (JPA No. 2002-243940); a method of using an adhesive having a storage elastic modulus at 90° C. of from 5×10⁵ Pa to 5×10⁹ Pa (JPA No. 2003-139952); a method of using a hot melt adhesive layer (JPA No. 2003-227928); and a method of performing a plasma discharge treatment in the presence of a reactive gas containing an organic compound having an unsaturated bond (JPA No. 2003-255131). However, all of these methods were insufficient in bonding between a polarizer and an alicyclic structure-containing polymer protective film.

### SUMMARY OF THE INVENTION

One object of the invention is to provide a polarizing plate having excellent adhesiveness between a protective film and a polarizer and reduced color unevenness and color deletion with time. Another object of the invention is to provide a process capable of stably producing the polarizer.

Under the above circumstances, the present inventors conducted various studies, and as a result, they found that, by using a protective film formed of a saturated alicyclic structure-containing thermoplastic polymer and by performing a surface treatment to a surface of the protective film to be bonded to a polarizer, it was possible to reduce color unevenness and color deletion with time. They also found that an amount of boric acid per unit volume in the polarizer, a transmittance at 410 nm when being disposed in a cross-Nicole position and a contact angle of the bonding surface of the protective film are important factors for further reducing color unevenness and color deletion with time. On the basis of these findings, the present invention was achieved.

From one aspect, the present invention provides a polarizing plate comprising:
a polyvinyl alcohol based polarizer,
a protective film comprising a saturated alicyclic structure-containing thermoplastic polymer, and
an adhesive layer comprising a water-soluble polymer between the protective film and the polarizer
wherein the surface of the protective film contacting with the adhesive layer is subjected to a surface treatment.

As the embodiments of the present invention, the polarizing plate wherein a contact angle of the surface of the protective film contacting with the adhesive layer against water is less than 50°; the polarizing plate wherein an amount of boric acid per unit volume in the polarizer is 200 kg/m³ or more; the polarizing plate giving a transmittance of 0.14% or less at 410 nm when being disposed in a cross-Nicole position; the polarizing plate wherein the water-soluble polymer is polyvinyl alcohol; the polarizing plate wherein the adhesive layer is a layer formed of a composition comprising a water-soluble polymer and a hardener, and the polarizing plate wherein the adhesive layer is a layer formed of a composition comprising at least one polyvinyl alcohol and a hardener; and the polarizing plate further comprising a retardation layer disposed on an opposite surface of the polarizer; are provided.

The saturated alicyclic structure-containing thermoplastic polymer may be a polymer produced by hydrogenating a ring-opening polymer of at least one norbornene based monomer. The hydrogenation rate of the polymer may be 90% or more. The sateraed alicyclic structure-containing thermoplastic polymer may be a hydrogenated polymer of tricycle[4.3.0.12,5]deca-3,7-diene, 1,4-metano-1,4,4a,9a-tetrahydrofluorene and tetracyclo-[4.4.0.12,5.17,10]-dodeca-3-ene.

As embodiment of the present invention, the polarizing plate having a single plate transmittance of 42.5% or more and 49.5% or less; and the polarizing plate having a degree of polarization of 99.900% or more and 99.999% or less; are provided.

The surface of the protective film contating with the adhesive layer may be subjected to a glow discharge treatment, a flame treatment or a corona discharge treatment.

From another aspect, the present invention provides a process for producing a polarizing plate comprising:
subjecting a surface of a film comprising a saturated alicyclic structure-containing thermoplastic polymer to a surface treatment; and
laminating the surface of the film having been subjected to a surface treatment and a surface of a polyvinyl alcohol based polarizer with an adhesive composition comprising a water-soluble polymer.

As embodiments of the present invention, the process comprising applying the adhesive composition on the surface of the film having been subjected to a surface treatment, thereby forming an adhesive layer, the process wherein the surface treatment is a glow discharge treatment, a flame treatment or a corona discharge treatment; the process wherein, as a result of the surface treatment, a contact angle of the surface of the film against pure water becomes less than 50°; the process wherein the water-soluble polymer is polyvinyl alcohol; and the process wherein the adhesive composition comprises at least one polyvinyl alcohol and a hardener; are provided.

The polarizing plate of the present invention is excellent in bonding between a polarizer and an alicyclic structure-containing polymer protective film, is less in color unevenness and color deletion in a large-scale liquid crystal display device, and is excellent in durability.

### BRIEF DESCRIPTION OF THE DRAWINGS

FIG. 1 is an outline cross-sectional view showing an example of a polarizing plate of the invention.

FIG. 2 is an outline schematic view showing an example of a liquid crystal display device using a polarizing plate of the invention.

Symbols in the drawings have the following meanings.
1: Upper polarizing plate
2: Upper polarizing plate absorption axis
3: Upper optically anisotropic layer
4: Upper optically anisotropic layer alignment control agent
5: Upper electrode substrate of liquid crystal cell
6: Upper substrate alignment control direction
7: Liquid crystal layer
8: Lower electrode substrate of liquid crystal call
9: Lower substrate alignment control direction
10: Lower optically anisotropic layer
11: Lower optically anisotropic layer alignment control direction
12: Lower polarizing plate
13: Lower polarizing plate absorption axis
101: Polarizer
102: Protective film
103: Functional film

### DETAILED DESCRIPTION OF THE INVENTION

The invention will be described below in detail.

1. Construction of Polarizing Plate:

First of all, a polarizer and a protective film of the invention, will be described.

(1) Polarizer:

A polarizer which is used in the invention is a polyvinyl alcohol (PVA) based polarizer. The polyvinyl alcohol based polarizer as referred to herein a polarizer mainly formed of a PVA film containing dichroic molecules.

PVA is a polymer raw material resulting from hydrolysis of polyvinyl acetate, and may contain a component which is copolymerizable with vinyl acetate, such as unsaturated carboxylic acids, unsaturated sulfonic acids, olefins, and vinyl ethers. Also, modified PVAs containing an acetoacetyl group, a sulfonic group, a carboxyl group, an oxyalkylene group, etc. can be used.

The degree of hydrolysis of PVA is not particularly limited but is preferably from 80 to 100 mole %, and especially preferably from 90 to 100 mole % from the viewpoint of solubility, etc. Also, the degree of polymerization of PVA is not particularly Iimted but is preferably from 1,000 to 10,000, and especially preferably from 1,500 to 5,000.

For the purpose of improving the durability, as described in Japanese Patent No. 2,978,219, the syndiotacticity of PVA is preferably 55% or more; however, PVA having the syndiotacticity of from 45 to 52.5% as described in Japanese Patent No. 3,317,494 can also be preferably employed.

It is preferable that after subjecting PVA to film formation, a dichroic molecule is introduced to produce a polarizer. As the production process of the PVA film, a process of casting a stock solution of a PVA based resin dissolved in water or an organic solvent to form a film is in general preferably employed. The concentration of the polyvinyl alcohol based resin in the stock solution is usually from 5 to 20% by weight, and by subjecting this stock solution to film formation by the casting process, a PVA film having a film thickness of from 10 to 200 μm can be produced. The production of the PVA film can be performed by referring to Japanese Patent No. 3,342,516, JPA No. hei 9-328593, JPA No. 2001-302817, and JPA No. 2002-144401.

The crystallinity of the PVA film is not particularly limited. However, there can be used PVA films having an average crystallinity (Xc) of from 50 to 75% by weight as described in Japanese Patent No. 3,251,073; and PVA films having a crystallinity of 38% or less as described in JPA No.2002-236214 for the purpose of reducing a scattering of hue within the plane.

It is preferable that the birefringence (Δn) of the PVA film is small, and PVA films having a birefringence of 1.0×10⁻³ or less as described in Japanese Patent No. 3,342,516 can be preferably used. However, for the purpose of obtaining a high degree of polarization while avoiding cutting at the time of stretching a PVA film, the birefringence of the PVA film may be controlled at 0.02 or more and 0.01 or less as described in JPA No. 2002-228835; and the value of (nx+ny)/2−nz may be controlled at 0.0003 or more and 0.01 or less as described in JPA No. 2002-60505. The retardation (in the plane) of the PVA film is preferably 0 nm or more and 100 nm or less, and more preferably 0 nm or more and 50 nm or less. Also, retardation, Rth (in the film thickness direction), of the PVA film is preferably 0 nm or more and 500 nm or less, and more preferably 0 nm or more and 300 nm or less.

Besides, for producing the polarizing plate of the invention, there can be preferably used PVA films having a 1,2-glycol binding amount of 1.5 mole % or less as described in Japanese Patent No. 3,021,494; PVA films containing optically foreign substances of 5 μm or more in the number of 500 or less per 100 cm² as described in JPA No. 2001-316492; PVA films having an unevenness of hot water cutting temperature in the TD direction of the film of 1.5° C. or less as described in JPA No. 2002-030163; PVA films formed of a solution containing from 1 to 100 parts by weight of a polyhydric alcohol, having a valence of from 3 to 6, such as glycerin; and PVA films formed of a solution containing 15% by weight or more of a plasticizer as described in JPA No. hei 6-289225.

The film thickness of the PVA film before stretching is not particularly limited but is preferably from 1 μm to 1 mm, and especially preferably from 20 to 200 μm from the viewpoints of stability of film and uniformity of stretching. Thin PVA films in which a stress generated when stretched in water by from 4 times to 6 times is 10 N or less, as described in JPA No. 2002-236212, may be used.

As the dichroic molecule, a high-order iodine ion such as I₃⁻ and I₅⁻ or a dichroic dye can be preferably used. In the invention, a high-order iodine ion is especially preferably used. The high-order iodine ion can be formed in the state that iodine is adsorbed and aligned on PVA by dipping PVA in a solution of iodine dissolved in a potassium iodide aqueous solution and/or a boric acid aqueous solution, as described in Henkoban No Oyo (Applications of Polarizing Plates), compiled by Ryo Nagata and published by CMC Publishing Co., Ltd. and Kogyo Zairyo (Engineering Materials), Vol. 28, No. 7, pp. 39-45.

In the case of using a dichroic dye as the dichroic molecule, azo based dyes are preferable, and bisazo based and trisazo based dyes are especially preferable. As the dichroic dye, ones which are water-soluble are preferable. For achieving this, ones in which a hydrophilic substituent such as a sulfonic group, an amino group, and a hydroxyl group is introduced into a dichroic molecule are preferably used as a free acid or an alkali metal salt, an ammonium salt or a salt of an amine.

Specific examples of such dichroic dyes include benzidine dyes such as C.I.Direct Red 37, Congo Red(C.I.Direct Red 28), C.I.Direct Violet 12, C.I.Direct Blue 90, C.I.Direct Blue 22, C.I.Direct Blue 1, C.I.Direct Blue 151 or C.I.Direct Green 1; Diphenyl urea dyes such as C.I.Direct Yellow 44, C.I.Direct Red 23 or C.I.Direct Red 79; stilbene dyes such as C.I.Direct Yellow 12; dinaphthylamine dyes such as C.I.Direct Red 31; and J acid dyes such as C.I.Direct Red 81, C.I.Direct Violet 9 or C.I.Direct Blue 78.

Other than these examples, C.I.Direct Yellow 8, C.I.Direct Yellow 28, C.I.Direct Yellow 86, C.I.Direct Yellow 87, C.I.Direct Yellow 142, C.I.Direct Orange 26, C.I.Direct Orange 39, C.I.Direct Orange 72, C.I.Direct Orange 106, C.I.Direct Orange 107, C.I.Direct Red 2, C.I.Direct Red 39, C.I.Direct Red 83, C.I.Direct Red 89, C.I.Direct Red 240, C.I.Direct Red 242, C.I.Direct Red 247, C.I.Direct Violet 48, C.I.Direct Violet 51, C.I.Direct Violet 98, C.I.Direct Blue 15, C.I.Direct Blue 67, C.I.Direct Blue 71, C.I.Direct Blue 98, C.I.Direct Blue 168, C.I.Direct Blue 202, C.I.Direct Blue 236, C.I.Direct Blue 249, C.I.Direct Blue 270, C.I.Direct Green 59, C.I.Direct Green 85, C.I.Direct Brown 44, C.I.Direct Brown 106, C.I.Direct Brown 195, C.I.Direct Brown 210, C.I.Direct Brown 223, C.I.Direct Brown 224, C.I.Direct Black 1, C.I.Direct Black 17, C.I.Direct Black 19 and C.I.Direct Black 54 can be also used. And the dichroic dyes, described in JPA No. syo 62-70802, JPA No. hei 1-161202, JPA No. hei 1-172906, JPA No. hei 1-172907, JPA No. hei 1-183602, JPA No. hei 1-248105, JPA No. hei 1-265205 or JPA No. hei 7-261024, can be also used preferably. For the purpose of preparing dichroic molecules having various hues, two or more kinds of these dichroic dyes may be blended. In the case of using a dichroic dye, the adsorption thickness may be 4 μm or more as described in JPA No.2002-82222.

When the content of the subject dichroic molecule in the film is too low, the degree of polarization is low, whereas when it is too high, the single plate transmittance is lowered. Accordingly, in general, it is preferable that the content is adjusted in the range of from 0.01% by weight to 5% by weight with respect to the polyvinyl alcohol based polymer constitudng the matrix of the film. The transmittance at 410 nm of the polarizing plate of the present invention when being disposed in a cross-Nicole position is preferably 0.14% or less, and the amount of the dichroic compound may be decided such that the polarizing plate gives the transmittance failing within the range at 410 nm.

The film thickness of the polarizer is preferably from 5 μm to 40 μm, and more preferably from 10 μm to 30 μm. It is also preferable that a ratio of the thickness of the polarizer to the thickness of a protective film as described later is in the range of 0.01≦A (film thickness of polarizer)/B (film thickness of protective film)≦0.16 as described in JPA No. 2002-174727.

(2) Protective Film:

The polarizer has a protective film made of a saturated alicyclic structure-containing thermoplastic polymer as the major component on at least one surface thereof. The both surfaces of the foregoing polarizer may have a protective film made of a saturated alicyclic structure-containing thermoplastic polymer as the major component

Examples of the saturated alicyclic structure-containing thermoplastic polymer include (1) norbornene based polymers, (2) polymers of a monocyclic olefin, (3) polymers of a cyclic conjugated diene, (4) vinyl alicyclic hydrocarbon polymers, and hydrides of (1) to (4). Of these, norbornene based polymer hydrides and vinyl alicyclic hydro-carbon polymers and hydrides thereof are preferable from the viewpoints of heat resistance, mechanical strength or the like.

Examples of the norbornene based polymers (1) and hydrides thereof include polymers of norbornene based monomers as the major component, such as norbornene and derivatives thereof, tetra-cyclododecene and derivatives thereof, dicyclo-penta-diene and derivatives thereof, and metanotetrahydrofluorene and derivatives thereof. More specifically, ring-opening polymers, ring-opening copolymers, addition polymers, addition copolymers, and hydrides thereof, of monomers such as norbornene and alkyl and/or alkylidene substitution products thereof, for example, 5-meth-yl-2-norbornene, 5-dimeth-yl-2-norbornene, 5-ethyl-2-nor-born-ene, 5-butyl-2-nor-bornene, and 5-ethylidene-2-nor-bornene, and substitution products thereof with a polar group such as halogens; dicyclopentadiene, 2,3-dihydrodicyclo-pentadiene, etc.; dimetanooctahydro-naphthalene and alkyl and/or alkylidene substitution products thereof and substitution products with a polar group such as halogens, for example, 6-methyl-1,4:5,8di-metano-1,4,4a,5,6,7,8,8a-octahydronaphthalene, 6-ethyl-1,4:5,8dimetano-1,4,4a,5,6,7,8,-8a-octahydronaphthalene, 6-ethylidene-1,4:5,8-dimetano-1,4,4a,5,6,7,8,8a-octahydronaphthalene, 6-chloro-1,4:5,8-dimetano-1,4,4a,5,6,7,8,8a-octahydronaphthalene, 6 -cyano-1,4:5,8-dimetano-1,4,-4a,5,6,7,8,8a-octahydronaphthalene, 6-pyridyl-1,4:5,8-dimetano-1,4,4a,5,6,7,8,8a-octaydro-naphthalene, and 6-methoxycarbonyl-1,4:5,8-dimetano-1,4,4a,5,6,7,8,8a-octahydronaphthalene; adducts of cyclopentadiene and teterahydroindene, etc.; trimers to tetramers of cyclopentadiene, for example, 4,9:5,8-dimetano-3a,4,4a,5,8,8a,9,9a-octahydro-1H-benzoindene and 4,-11:5,10:6,9-trimetano-3a,4,4a,5,5a,6,9,9a,10,10a,11,11a-dodecahydro-1H-cyclopentaanthracene are preferable, and these hydrides are more preferable. Of these, ring-opening polymer hydrides of norbornene based monomers are much more preferable from the viewpoints of heat resistance, mechanical strength or the like.

The molecular weight of the ring-opening polymer hydride of a norbornene based monomer is properly set according to the use purpose but is usually in the range of from 5,000 to 500,000, preferably from 8,000 to 200,000, and more preferably from 10,000 to 100,000, from the viewpoint of a good balance between the mechanical strength and the molding processability of the protective film. The Mw can be measured as a polystyrene or polyisoprene equivalent molecular weight with gel permeation chromatography (GPC) of its cyclohexane solution (a toluene solution in the case where the polymer is not dissolved).

The vinyl alicyclic hydrocarbon polymer (4) is a polymer having a repeating unit derived from a vinylcycloalkane or a vinylcycloalkene. Examples thereof include polymers of vinyl group-containing cycloalkanes or vinyl group-containing cycloalkenes such as vinylcyclohexene and vinylcyclohexane, namely polymers of vinyl alicyclic hydrocarbon compounds and hydrides thereof; and hydrides of polymers of vinyl aromatic hydrocarbons such as styrene and α-methylstyrene, in which the aromatic ring moieties thereof are hydrogenated. The vinyl alicyclic hydrocarbon polymer may be a copolymer such as a random copolymer or block copolymer of a vinyl alicyclic hydrocarbon compound or a vinyl aromatic hydrocarbon compound and other monomer which is copolymerizable with the preceding monomer, or a hydride thereof. Examples of the block copolymer include diblock, triblock or multi-block or inclined block copolymers, but the block copolymer is not particularly limited. The molecular weight of the vinyl alicyclic hydrocarbon polymer is properly set according to the use purpose but is usually in the range of from 10,000 to 300,000, preferably from 15,000 to 250,000, and more preferably from 20,000 to 200,000, from the viewpoint of a good balance between the mechanical strength and molding processability of the polymer. The Mw can be measured as a polystyrene or polyisoprene equivalent molecular weight with gel permeation chromatography (GPC) of its cyclohexane solution (a toluene solution in the case where the polymer is not dissolved).

In the case where the alicyclic structure-containing polymer is obtained by hydrogenating a ring-opening polymer of a norbornene based monomer, the hydrogenation rate is usually 90% or more, preferably 95% or more, and more preferably 99% or more from the viewpoints of resistance to heat deterioration, resistance to light deterioration or the like.

The alicyclic structure-containing polymer is excellent in transparency, heat resistance, moisture resistance, physical strength, adhesiveness with an adhesive, durability to an adhesive, and so on. A 25 μm-thick sheet thereof usually having a hygroscopicity of 0.05% or less, and preferably 0.01% or less and having a water vapor permeability of 20 g/m²·24 hr or less in the environment at 25° C. and 90% RH can be easily obtained. Also, since its optical elastic coefficient is low as from 3 to 9×10⁻¹⁵ cm²/dyne, even when an external force is applied or a residual stress is present, an influence against the retardation is small so that it is suitable for the production of an optically uniform film.

If desired, various additives such as phenol based or phosphorus based anti-aging agents, antistatic agents and ultraviolet absorbers may be added to the alicyclic structure-containing polymer which is used in the invention. In particular, since a liquid crystal is usually deteriorated by ultraviolet light, in the case where protection means such as lamination of an ultraviolet protective film is not taken, it is preferred to add an ultraviolet absorber. As the ultraviolet absorber, benzophenone based ultraviolet absorbers, benzotriazole based ultraviolet absorbers, acrylonitrile based ultraviolet absorbers, and the like can be used. Of these, benzophenone based ultraviolet absorbers are preferable. The addition amount thereof is usually from 10 to 100,000 ppm, and preferably from 100 to 10,000 ppm. Also, in the case where a sheet is prepared by the solution casting process, for the purpose of making the surface roughness low, it is preferred to add a leveling agent. As the leveling agent, leveling agents for paints such as fluorine based nonionic surfactants, special acrylic resin based leveling agents, and silicone based leveling agents can be used. Of these, ones having good compatibility with a solvent are preferable. The addition amount thereof is usually from 5 to 50,000 ppm, and preferably from 10 to 20,000 ppm.

The glass transition temperature (Tg) of the alicyclic structure-containing polymer is properly set according to the use purpose but is usually not smaller than 80° C., preferably from 100 to 250° C., and more preferably from 120 to 200° C., from the viewpoint of a good balance between the thermostability and the molding processability of the polymer.

As the alicyclic structure-containing polymer protective film, ZEONEX (references: JPA No. syo 63-218726, JPA No. hei 5-25220, and JPA No. hei 9-183832) and ZEONOR, all of which are manufactured by ZEON Corporation and ARTON manufactured by JSR Corporation (references: JPA No. hei 1-24051 and JPA No. hei 5-97978) are especially preferable.

(2-2) Production of Protective Film:

Examples of the production process of a protective film made of the foregoing alicyclic structure-containing polymer include a hot melt molding process and a solution casting process. In more detail, the hot melt molding process can be classified into an extrusion molding process, a press molding process, an inflation molding process, an injection molding process, a blow molding process, a stretch molding process, and the like. Of these processes, for the purpose of obtaining a film which is excellent in mechanical strength, surface precision, etc., an extrusion molding process, an inflation molding process, and a press molding process are preferable, with the extrusion molding process being the most preferable. The molding condition is properly set according to the use purpose and molding process. In the case of employing a hot melt molding process, the cylinder temperature is properly set up within the range of usually from 150 to 400° C., preferably from 200 to 350° C., and more preferably from 230 to 330° C. When the resin temperate is excessively low, the fluidity becomes worse so that sink marks or strains are generated in the film; and when it is excessively high, voids or silver streaks are generated due to heat decomposition of the resin, thereby possibly generating molding defects such as yellowing of the resin.

The thickness of the foregoing protective film is preferably from 10 to 100 μm, and more preferably from 20 to 80 μm. It is preferable that the protective film to be aligned in the liquid crystal cell side is a polymer film which does not substantially change the polarizing state of light coming from the front, namely one having a small in-plane retardation (Re). Specifically, the Re value is preferably 0 nm or more and 20 nm or less, and especially preferably 0 nm or more and 5 nm or less. The Rth value is preferably 0 nm or more and 200 nm or less, and more preferably 0 nm or more and 180 nm or less. A variation of each of the Re value and the Rth value preferably falls within ±3 nm, and most preferably ±2 nm of the average value.

In the specification, Re and Rth respectively mean an in-plane retardation and a retardation in a thickness-direction at wavelength 589 nm. The Re is measured by using KOBRA-21ADH (manufactured by Oji Scientific Instruments) for an incoming light of a wavelength 589 nm in a direction normal to a film-surface. The Rth is calculated by using KOBRA-21ADH based on three retardation values; first one of which is the Re obtained above, second one of which is a retardation which is measured for an incoming light of a wavelength 589 nm in a direction rotated by +40° with respect to the normal direction of the film-surface around an in-plane slow axis, which is decided by KOBRA 21ADH, as an a tilt axis (a rotation axis), and third one of which is a retardation which is measured for an incoming light of a wavelength 589 nm in a direction rotated by −40° with respect to the normal direction of the film-surface around an in-plane slow axis as an a inclining axis (a rotation axis). It is also required to enter a hypothetical mean refractive index and a thickness of the film.

The mean refractive indexes of other various materials are described in published documents such as “POLYMER HANDBOOK” (JOHN WILEY&SONS, INC) and catalogs. If the values are unknown, the values may be measured with an abbe refractometer or the like.

The mean refractive indexes of optical films are exemplified below:
cellulose acylate (1.48), cyclo-olefin polymer (1.52), polycarbonate (1.59), polymethyl methacrylate (1.49), polystyrene (1.59).

When these mean refractive indexes and a thickness are entered, KOBRA 21ADH calculates nx, ny and nz.

(2-3) Surface Treatment of Protective Film:

In the invention, for the purpose of improving adhesiveness between the polarizer and the protective film, the surface of the alicyclic structure structure-containing polymer protective film is subjected to a surface treatment. With respect to the surface treatment, any method may be utilized so far as it is able to improve the adhesiveness. Preferred examples of the surface treatment include a glow discharge treatment, an ultraviolet irradiation treatment, a corona treatment, and a flame treatment. The glow discharge treatment as referred to herein is a so-called low-temperature plasma occurred under a low-pressure gas. In the invention, a plasma treatment under the atmospheric pressure is also preferable. Besides, the details of the glow discharge treatment are described in U.S. Pat. No. 3,462,335, U.S. Pat. No. 3,761,299, U.S. Pat. No. 4,072,769, and U.K, Patent No. 891,469. A method described in JPT No. syo 59-556430 (the term “JPT” as used herein means an “unexamined published Japanese patent application (Tokkyo Kohyo)”).in which the gas composition of the discharge atmosphere is limited to only a gas species generated within a vessel when after starting the discharge, a polyester support itself is subjected to a discharge treatment is also employed. Also, a method described in JPB No. syo 60-16614 (the term “JPB” as used herein means an “examined published Japanese patent application (Tokkyo Kohkoku)”) in which in performing a vacuum glow discharge treatment, the discharge treatment is performed at a surface temperature of the film of 80° C. or higher and 180° C. or lower can be employed.

At the time of glow discharge treatment, the degree of vacuum is preferably from 0.5 to 3,000 Pa, and more preferably from 2 to 300 Pa. Also, the voltage is preferably from 500 to 5,000 V, and more preferably from 500 to 3,000 V. The discharge frequency to be used is preferably from a direct current to several thousands MHz, more preferably from 50 Hz to 20 MHz, and further preferably from 1 kHz to 1 MHz. The discharge treatment intensity is preferably from 0.01 kV·A·min/m to 5 kV·A·min/m², and more preferably from 0.15 kV·A·min/m² to 1 kV·A·min/m².

In the invention, it is also preferred to perform an ultraviolet irradiation process as the surface treatment. For example, this can be achieved according to a treatment process described in each of JPB No. syo 43-2603, JPB No. syo 43-2604, and JPB No. syo 45-3828. A mercury vapor lamp is preferably a high pressure mercury vapor lamp composed of a quartz tube and having a wavelength of ultraviolet light of from 180 to 380 nm. With respect to the method of ultraviolet irradiation, it is possible to use a high pressure mercury vapor lamp having a dominant wavelength of 365 nm so far as there is no problem in performance of the support even when a light source raises the surface temperature of the protective film at around 150° C. In the case where a low-temperature treatment is required, a low pressure mercury vapor lamp having a dominant wavelength of 254 nm is preferable. Also, it is possible to use ozone-less type high pressure mercury vapor lamps and low pressure mercury vapor lamps. With respect to the quantity of treating light, when the quantity of treating light increases, an adhesive force between the thermoplastic saturated alicyclic structure-containing polymer film and the polarizer is enhanced. However, there is generated a problem that the subject film is colored with an increase of the quantity of light and becomes brittle. Accordingly, a high pressure mercury vapor lamp having a dominant wavelength of 365 nm preferably has a quantity of irradiating light of from 20 to 10,000 (mJ/cm²), and more preferably from 50 to 2,000 (mJ/cm²). In the case of a low pressure mercury vapor lamp having a dominant wavelength of 254 nm, the quantity of irradiating light is preferably from 100 to 10,000 (mJ/cm²), and more preferably from 300 to 1,500 (mJ/cm²).

Further, in the invention, it is preferred to perform a corona discharge treatment as the surface treatment. For example, this can be achieved according to a treatment method described in each of JPB No. syo 39-12838, JPA No. syo 47-19824, JPA No. syo 48-28067, and JPA No. syo 52-42114. As the corona discharge treatment device, a Pillar's solid state corona treatment device, a LEPEL type surface treatment device, a VETAPHON type treatment device, and so on can be employed. The treatment can be performed under a normal pressure in air. At the time of treatment, the discharge frequency is preferably from 5 to 40 kV, and more preferably 10 to 30 kV; and the wave form is preferably an alternating current sine wave. A gap clearance between an electrode and a dielectric roll is preferably from 0.1 to 10 mm, and more preferably from 1.0 to 2.0 mm. The discharge is performed in an upper portion of a dielectric support roll provided in the discharge band, and the treatment amount is preferably from 0.3 to 0.4 kV·A min/m², and more preferably from 0.34 to 0.38 kV·A·min/m².

In the invention, it is also preferable that a flame treatment is performed as the surface treatment. As a gas to be used, any of a natural gas, a liquefied propane gas, or a city gas may be used, but a mixing ratio to air is important. This is because it is considered that an effect of the surface treatment by the flame treatment is brought by an active oxygen-containing plasma, and how extent activity (temperature) of the plasma and oxygen as important properties of the flame are present is the point of issue. A dominant factor of this point is a gas/oxygen ratio, and when the both react with each other neither too much nor too little, the energy density becomes the highest, and the activity of the plasma becomes high. Specifically, a suitable natural gas/air mixing ratio is from 1/6 to 1/10, and preferably from 1/7 to 1/9 in terms of a volume ratio. Also, in the case of liquefied propane gas/air, it is from 1/14 to 1/22, and preferably from 1/16 to 1/19; and in the case of city gas/air, it is from 1/2 to 1/8, and preferably from 1/3 to 1/7. Also, the treatment may be performed in the treatment amount of flame in the range of from 1 to 50 kcal/m², and preferably from 3 to 20 kcal/m². Also, a distance between the tip of an inner flame of a burner and a film is preferably from 3 to 7 cm, and more preferably from 4 to 6 cm. As the nozzle shape of the burner, a ribbon type of Flynn Burner Corporation (U.S.A.), a multi-opening type of Weiss (U.S.A.), a ribbon type of Aerogen (U.K.), a staggered multi-opening type of Kasuga Ew Co., Ltd (Japan), and a staggered multi-opening type of Koike Sanso Kogyo Co., Ltd. (Japan) are preferable. A backup roll which supports the film in the flame treatment is a hollow roll, and it is suitable that the treatment is performed always at a constant temperature of from 20 to 50° C. while water cooling by passing cooling water therethrough.

The degree of the surface treatment varies with respect to its preferred range depending upon the kind of the surface treatment and the kind of the saturated alicyclic structure-containing polymer. It is preferable that as a result of the surface treatment, a contact angle of the surface of the protective film having been subjected to a surface treatment against pure water becomes less than 50°. The foregoing contact angle is more preferably 25° or more and less than 45°. When the contact angle of the surface of the protective film against pure water falls within the foregoing range, an adhesive strength between a protective film and a polarizing film becomes satisfactory

(3) Adhesive:

In the invention, in laminating the polarizer made of polyvinyl alcohol and the protective film made of a thermoplastic saturated alicyclic structure-containing polymer, which has been subjected to a surface treatment, an adhesive containing a water-soluble polymer is used.

Examples of the water-soluble polymer which is preferably used in the foregoing adhesive include homopolymers or copolymers containing as a constitutional element an ethylenically unsaturated monomer such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylaride, diacetone acrylamide, and vinylimidazole; and polyoxyethylene, polyoxypropylene, poly-2-methyloxazoline, methyl cellulose, hydroxyethyl cellulose, hydroxypropyl cellulose, and gelatin. Of these, PVA and gelatin are preferable in the invention.

In the case where PVA is used as the adhesive, a preferred PVA characteristic is the same as the preferred characteristic of PVA to be used in the polarizer as described previously. In the invention, it is preferred to further use a crosslinking agent in combination. In the case where PVA is used as the adhesive, examples of the crosslinking agent which is preferably used in combination include boric acid, polyhydric aldehydes, polyfunctional isocyanate compounds, and polyfunctional epoxy compounds. In the invention, boric acid is especially preferable.

In the case where gelatin is used as the adhesive, called lime-treated gelatins, acid-treated gelatins, enzyme-treated gelatins, gelatin derivatives, modified gelatins, and so on can be used. Of these gelatins, lime-treated gelatins and acid-treated gelatins are preferable for use. In the case where gelatin is used as the adhesive, examples of the crosslinking agent which is preferably used in combination include active halogen compounds (for example, 2,4-dichloro-6-hydroxy-1,3,5-triazine and a sodium salt thereof), active vinyl compounds (for example, 1,3-bisvinylsulfonyl-2-propanol, 1,2-bisvinylsulfonyl acetamidoethane, bis(vinylsulfonylmethyl) ether, and vinyl based polymers having a vinylsulfonyl group in the side chain thereof), N-carbamoylpyridinium salts (for example, (1-morpholinocarbonyl-3-pyridinio)methanesulfonate), and haloamidinium salts (for example, 1-(1-chloro-1-pyridinomethylene)pyridinium 2-naphthalenesulfonate). In the invention, active halogen compounds and active vinyl compounds are especially preferably used.

In the case where the foregoing crosslinking agent is used in combination, the addition amount of the crosslinking agent is preferably 0.1% by weight or more and less than 40% by weight, and more preferably 0.5% by weight or more and less than 30% by weight with respect to the water-soluble polymer in the adhesive. It is preferable that the adhesive is applied to at least one surface of the protective film or the polarrer to form an adhesive layer, thereby achieving the lamination, and it is more preferable that the adhesive is applied to the surface-treated face of the protective film to form an adhesive layer, which is then laminated on the surface of the polarizer. The thickness of the adhesive layer is preferably from 0.01 to 5 μm, and especially preferably from 0.05 to 3 μm after drying.

2. Production Process of Polarizing Plate:

Next, the production process of the polarizing plate of the invention will be described.

According to the present invention, as the transmittance at 410 nm obtained from the polarizing plate disposed in a cross-Nicole position is lower, it is more preferred. However, when the transmittance at 410 nm is too low, the single plate transmittance of the polarizing plate tends to lower, and, in practice, the transmittance at 410 nm is higher than 0.01%. Namely, the transmittance at 410 nm obtained from the polarizing plate of the present invention disposed in a cross-Nicole position is preferably not higher than 0.14%, more preferably from 0.01 to 0.14% and much more preferably from 0.01 to 0.12%. And, according to the present invention, as the mount of boric acid per unit volume in the polarizer is greater, it is more preferred. However, when the amount of the boric acid is too much, the transmittance at a long wavelength (from 600 nm to 700 nm) obtained from the polarizing plate of the present invention disposed in a cross-Nicole position tends to increase and, as a result, the hue turns to be reddish. In practice, the amount of boric acid unit in the polarizer is not greater than 500 kg/m³. Namely, the amount of boric acid per unit volume in the polarizer is preferably not less than 200 kg/m³, and more preferably from 200 to 500 kg/m³.

The transmittance of the polarizing plate disposed in a cross-Nicole position and the amount of boric acid contained in the polarizer may be set within the above preferred range by controlling the conditions in any steps included in a preparing process or the amounts of compounds to be added.

<Method for Lowering Pittance at 410 nm in a Cross-Nicole Position>

The methods for lowering transmittance at 410 nm in a cross-Nicole position may be carried out in a dyeing step or a hardening step described later.

There are examples of the methods for lowering transmittance at 410 nm in a cross-Nicole position as follows:
1) To increase the dyeing amount with iodine in a dyeing step;
2) To control the amount of potassium iodide in a hardened layer liquid used in a hardening step;
3) To add iodine to a hardened layer liquid used in a hardening step; or
4) To add boric acid to a dyeing liquid used in a dyeing step.

Among these, the methods 2) to 4) are preferred since the transmittance in a cross-Nicole position can be reduced to the preferred range without lowering the single plate transmittance or the quality of the polarizing plate. Especially, the methods 2) and 3) are more preferred. However, any methods other than the above 1) to 4) methods may be used as long as they can reduce the transmittance in a cross-Nicole position can be reduced to the preferred range without lowering the single plate transmittance or the quality of the polarizing plate. Two or more methods in combination may be carried out.

<Method for Increasing the Amount of Boric Acid Per Unit Volume>

The methods for increasing the amount of boric acid per unit volume may be carried out in a hardening step described later.

There are examples of the methods for increasing the amount of boric acid per unit volume as follows:
5) To increase a temperature of a hardened layer liquid;
6) To lengthen the time for a hardening step; or
7) To increase a concentration of boric acid in a hardened layer liquid.

Any methods other than the above 5) to 7) methods may be used as long as they can increase the amount of boric acid per unit volume in the polarizer Two or more methods in combination may be carried out.

It is preferable that the production process of the polarizing plate of the invention includes a swelling step, a dyeing step, a hardening step, a stretching step, a drying step, a protective film-laminating step, and a drying step after lamination. The order of the dyeing step, the hardening step and the stretching step is arbitrary; and some of these steps may be combined and performed at the same time. Also, it is preferred to perform water washing after the hardening step as described in Japanese Patent No. 3,331,615.

In the invention, it is especially preferred to successively perform a swelling step, a dyeing step, a hardening step, a stretching step, a drying step, a protective film-laminating step, and a drying step after lamination in the described order. Also, during or after the foregoing steps, an on-line plane condition inspection step may be provided.

The swelling step is a step of dipping a PVA film in a liquid, thereby swelling the PVA film. Though it is preferable that the swelling is performed using only water, it is possible to swell a polarizing plate substrate in a boric acid aqueous solution, thereby controlling a degree of swelling of the polarizing plate substrate for the purposes of stabilizing the optical performance and avoiding the generation of wrinkles of the polarizing plate substrate on the production line as described in JPA No. hei 10-153709.

Also, though the temperature and time of the swelling step can be arbitrarily defined, it is preferable that the swelling step is performed at 10° C. or higher and 60° C. or lower for 5 seconds or more and 2,000 seconds or less.

The dyeing step is a step of dyeing the swollen PVA film with a dichroic dye. A method described in JPA No. 2002-86554 can be employed. Also, as the dyeing method, not only dipping but also arbitrary means such as coating or spraying of an iodine or dye solution can be employed. Also, a method described in JPA No. 2001-290025, in which dyeing is performed while stirring a bath solution in a bath under specified conditions of concentration of iodine, temperature of a dyeing bath and stretch ratio in the bath, may be employed.

In the case where a high-order iodine ion is used as a dichroic molecule in the dyeing step, in order to obtain a polarizing plate having a high contrast, it is preferred to use a solution of iodine dissolved in a potassium iodide aqueous solution in the dyeing step. In this case, it is preferable that the concentrations of iodine and potassium iodide in the iodine-potassium iodide aqueous solution are in the range of from 0.05 to 20 g/liter and in the range of from 3 to 200 g/liter, respectively, with a weight ratio of iodine to potassium iodide being in the range of from 1 to 2,000. The dyeing time is preferably from 10 to 1,200 seconds, and the solution temperature is preferably from 10 to 60° C. More preferably, the concentrations of iodine and potassium iodide are from 0.5 to 2 g/liter and from 30 to 120 g/liter, respectively, with a weight ratio of iodine to potassium iodide being in the range of from 30 to 120; and the dyeing time is from 30 to 600 seconds, and the solution temperature is from 20 to 50° C.

Also, as described in Japanese Patent No. 3,145,747, a boron based compound such as boric acid and borax may be added to the dyeing solution.

The amount of the compound is desirably set within a range such that the transmittance at 410 nm of the polarizing plate disposed in a cross-Nicole position is not higher than 0.14%.

The hardening step is a step of hardening the PVA film by a crosslinking agent It is preferred to dip it in a crosslinking agent solution or coating the solution thereon, thereby containing the crosslinking agent. Also, as described in JPA No. hei 11-52130, the hardening step can be performed by dividing into several times. As the crosslinking agent, ones described in U.S. Reissue Pat. No. 232,897 can be used; and as described in Japanese Patent No. 3,357,109, for the purpose of enhancing the dimensional stability, a polyhydric aldehyde can be used as the crosslinking agent. However, boric acids are most preferably used. In the case where boric acid is used as the crosslinking agent to be used for the hardening step, a metal ion may be added to a boric acid-potassium iodide aqueous solution. Zinc chloride is preferable as the metal ion. However, as described in JPA No. 2000-35512, zinc halides such as zinc iodide and zinc salts such as zinc sulfate and zinc acetate can be also used in place of the zinc chloride.

In the invention, the hardening is preferably performed by preparing a boric acid-potassium iodide aqueous solution having zinc chloride added thereto and dipping the PVA film therein. Preferably, the concentration of boric acid is from 1 to 100 g/liter; the concentration of potassium iodide is from 1 to 120 g/liter; the concentration of zinc chloride is from 0.01 to 10 g/liter; the hardening time is from 10 to 1,200 seconds; and the solution temperature is from 10 to 60° C. More preferably, the concentration of boric acid is from 10 to 80 g/liter; the concentration of potassium iodide is from 5 to 100 g/liter; the concentration of zinc chloride is from 0.02 to 8 g/liter; the hardening time is from 30 to 600 seconds; and the solution temperature is from 20 to 50° C. According to the present invention, the amount of boric acid per unit volume in the polarizer is preferably not less than 200 kg/m³.

The stretching step is a step of stretching the dyed PVA film to form a polarize. A longitudinal uniaxial stretching system as described in U.S. Pat. No. 2,454,515 or a tenter system as described in JPA No. 2002-86554 can be preferably employed. A stretch ratio is preferably 2 times or more and 12 times or less, and more preferably 3 times or more and 10 times or less. Also, the relationship among the stretch ratio, the thickness of a raw film and the thickness of a polarizer can be preferably controlled at {[(film thickness of a polarizer after laminating a protective film)/(film thickness of a raw film)]×(total stretch ratio)]>0.17}, as described JPA No. 2002-40256; and the relationship between the width of a polarizer at the time of leaving a final bath and the width of a polarizer at the time of laminating a protective film can be preferably controlled at {0.80≦[(width of a polarizer at the time of laminating a protective film)/(width of a polarizer at the time of leaving a final bath)]≦0.95}, as described in JPA No. 2002-40247.

As the drying step, a known method by JPA No. 2002-86554 can be employed. A preferred temperature range is from 30° C. to 100° C., and a preferred drying time is from 30 seconds to 60 minutes. Also, it is possible to preferably perform a heat treatment at an underwater fading temperature of 50° C. or higher as described in Japanese Patent No. 3,148,513 or aging in an atmosphere where the temperature and humidity are controlled as described in JPA No. hei 7-325215 and JPA No. hei 7-325218.

The protective film-laminating step is a step of laminating a protective film on the both faces of the dried polarizer. In the invention, a film of the saturated alicyclic structure-containing thermoplastic polymer is laminated on the polarizer in the manner that the surface subjected to the surface treatment of the film is faced toward the polarizer. A film of the saturated alicyclic structure-containing thermoplastic polymer having been subjected to a surface treatment may be laminated on the both faces as a protective film, or a polymer film of other kind may be laminated on one of the faces of the polarize. In the case of laminating a film of the saturated alicyclic structure-containing thermoplastic polymer having been subjected to a surface treatment, the lamination is performed using an adhesive composition (adhesive) containing the foregoing water-soluble polymer. The lamination may be performed by using an adhesive film prepared by previously coating the foregoing adhesive composition on the surface-treated face of the foregoing protective film to form an adhesive layer. The lamination can be performed by bringing the adhesive layer into contact with the surface of the polarizer and then applying a pressure and/or heating, if desired. Also, an adhesive liquid may be fed just before lamination and lamination may be then performed using a pair of rolls such that the polarizer and the protective film are superimposed each other. Incidentally, as described previously, it is preferable that the surface treatment is performed to such extent that the face in the side to which the protective film is bonded has a contact angle against pure water of less than 50°. Further, as described in JPA No. 2001-296426 and JPA No. 2002-86554, in order to inhibit a record disc groove-like projecting and recessing shape due to stretching of a polarizer, it is preferred to adjust the water content of the polarizer at the time of lamination. In the invention, a water content of from 0.1% to 10% is preferably employed.

The drying condition after lamination may follow a method described in JPA No. 2002-86554. A preferred temperature range is from 30° C. to 100° C., and a preferred drying time is from 30 seconds to 60 minutes. Also, as described in JPA No. hei 7-325220, it is preferred to perform aging in an atmosphere where the temperature and humidity are controlled.

The element content in the polarizer is preferably from 0.1 to 3.0 g/m² for iodine, from 0.1 to 5.0 g/m² for boron, from 0.1 to 2.0 g/m² for potassium, and from 0 to 2.0 g/m² for zinc, respectively. Also, the potassium content may be 0.2% by weight or less as described in JPA No. 2001-166143; and the zinc content in the polarizer may be from 0.04% by weight to 0.5% by weight as described in JPA No. hei 12-035512.

As described in Japanese Patent No. 3,323,255, for the purpose of improving the dimensional stability of the polarizing plate, it is possible to add and use an organotitanium compound and/or an organozirconium compound in any one of the dyeing step, the stretching step and the hardening step, thereby containing at least one kind of compound selected from organotitanium compounds and organozirconium compounds. Also, for the purpose of adjusting the hue of the polarizing plate, a dichroic dye may be added.

3. Characteristics of Polarizing Plate:

(1) Transmittance and Degree of Polarization:

A single plate transmittance of the polarizing plate of the invention is preferably 42.5% or more and 49.5% or less, and more preferably 42.8% or more and 49.0% or less. A range of a degree of polarization defined according to the following expression 4 is preferably 99.900% or more and 99.999% or less, and more preferably 99.940% or more and 99.995% or less. A preferred range of a parallel transmittance is 36% or more and 42% or less; and a preferred range of a cross trnsmittance is 0.001% or more and 0.05% or less. A range of a dichroic ratio defined according to the following expression 5 is preferably 48 or more and 1,215 or less, and more preferably 53 or more and 525 or less. The foregoing transmittance is defined according to the following expression (2) according to JIS Z8701.
T=K ∫S(λ)y(λ)τ(λ)dλ (Expression 2)

Here, S(λ) represents a spectral distribution of standard light to be used for color display; y(λ) represents a color matching function in the XYZ-system; τ(λ) represents a spectral transmittance; and K is defined according to the following expression (3).

$$\begin{matrix}K = \frac{100}{\int S ( λ ) y ( λ ) ⅆ λ} & ( Expression 3 ) \\ Degree of polarization ( \% ) = 100 \times \sqrt{\frac{\begin{matrix}Parallel transmittance - \\ Crossed transmittance\end{matrix}}{\begin{matrix}Parallel transmittance + \\ Crossed transmittance\end{matrix}}} \\ & ( Expression 4 ) \\ Dichroic ratio ( Rd ) = \frac{log [ \begin{matrix}\frac{Single plate transmittance}{100} \\ ( 1 - \frac{Degree of polarization}{100} )\end{matrix} ]}{log [ \begin{matrix}\frac{Single plate transmittance}{100} \\ ( 1 + \frac{Degree of polarization}{100} )\end{matrix} ]} & ( Expression 5 )\end{matrix}$$

The iodine concentration and single plate transmittance of the polarizing plate of the invention may be in the ranges as described in JPA No. 2002-258051.

The parallel transmittance of the polarizing plate of the invention may be small in wavelength dependency as described in JPA No. 2001-83328 and JPA No. 2002-22950. The optical characteristic in the case of disposing the polarizing plate in the cross-Nicole position may be in the range as described in JPA No. 2001-91736; and the relationship between the parallel transmittance and the cross transmittance may fall within the range as described in JPA No. 2002-174728.

As described in JPA No. 2002-221618, the polarizing plate of the invention may have a standard deviation of parallel transmittance, as measured in increments of 10 nm between 420 nm and 700 nm in the wavelength of light, of 3 or less and a minimum value of (parallel transmittance/crossed transmittance), as measured in increments of 10 nm between 420 nm and 700 nm in the wavelength of light, of 300 or more.

The polarizing plate of the invention may preferably have ranges of a parallel transmittance and a cross transmittance in the wavelength of 440 nm, a parallel transmittance and a cross transmittance in the wavelength of 550 nm, a parallel transmittance and a cross transmittance in the wavelength of610 nm as described in JPA No. 2002-258042 and JPA No. 2002-258043.

(2) Hue:

The hue of the polarizing plate of the invention is preferably evaluated using a lightness index L* and chromaticness indices a* and b* in the L*a*b* notation system recommended as a CIE uniform color space.

L*, a* and b* are defined using the foregoing X, Y and Z according to the expression 6.

(Expression 6)

$${L}^{*} = 116 {( Y / {Y}_{0} )}^{\frac{1}{3}} - 16$$

$${a}^{*} = 500 [ {( X / {X}_{0} )}^{\frac{1}{3}} - {( Y / {Y}_{0} )}^{\frac{1}{3}} ]$$

$${b}^{*} = 200 [ {( Y / {Y}_{0} )}^{\frac{1}{3}} - {( Z / {Z}_{0} )}^{\frac{1}{3}} ]$$

Here, X₀, Y₀ and Z₀ represent tristimulus values of an illumination light source; in the case of standard light C, X₀=98.072, Y₀=100, and Z₀=118.225; and in the case of standard light D₆₅, X₀=95.045, Y₀=100, and Z₀=108.892.

The range of a* of a single sheet of the polarizing plate is preferably −2.5 or more and 0.2 or less, and more preferably −2.0 or more and 0 or less. The range of b* of a single sheet of the polarizing plate is preferably 1.5 or more and 5 or less, and more preferably 2 or more and 4.5 or less. The range of a* of the parallel transmitted light between two sheets of the polarizing plate is preferably −4.0 or more and 0 or less, and more preferably −3.5 or more and −0.5 or less. The range of b* of the parallel transmitted light between two sheets of the polarizing plate is preferably 2.0 or more and 8 or less, and more preferably 2.5 or more and 7 or less. The range of a* of the crossed transmitted light between two sheets of the polarizing plate is preferably −0.5 or more and 1.0 or less, and more preferably 0 or more and 2 or less. The range of b* of the crossed transmitted light between two sheets of the polarizing plate is preferably −2.0 or more and 2 or less, and more preferably −1.5 or more and 0.5 or less.

The hue may be evaluated by the chromaticity coordinate (x, y) as calculated from the foregoing X, Y and Z. For example, the chromaticity (xₚ, yₚ) of the parallel transmitted light and the chromaticity (x_{c}, y_{c}) of the crossed transmitted light between two sheets of the polarizing plate can be preferably made to fall within the ranges as described in JPA No. 2002-214436, JPA No. 2001-166136, and JPA No. 2002-169024, and the relationship of the hue and the absorbance can be preferably made to fall within the range as described in JPA No. 2001-311827.

(3) Viewing Angle Characteristic:

In the case of disposing the polarizing plate of the invention in the cross-Nicole position and entering light having a wavelength of 550 nm, it is preferable that a transmittance ratio and an xy chromaticity difference between the case of entering vertical light and the case of entering light at an angle of 40° against the normal from the azimuth of 45° against the polarization axis are made to fall within the ranges as described in JPA No. 2001-166135 and JPA No. 2001-166137. Also, it is preferable that a ratio (T₆₀/T₀) of the light transmittance (T₆₀) in the tilt direction of 60° from the normal of a laminate of polarizing plates disposed in the cross-Nicole position to the light transmittance (T₀) in the vertical direction of the laminate is controlled at 10,000 or less as described in JPA No. hei 10-68817; that in the case of entering natural light into a polarizing plate at an arbitrary angle up to the elevation of 80° from the normal, a difference in the transmittance of the transmitted light within the wavelength region of 20 nm in the wavelength range of its transmission spectrum of from 520 to 640 nm is controlled at 6% or less as described in JPA No. 2002-139625; and that a difference in the illuminance in arbitrary places of a film far from each other by 1 cm is controlled within 30% as described in JPA No. hei 8-248201.

(4) Durability:

(4-1) Wet Heat Durability:

In the polarizing plate of the invention, it is preferable that change rates of the light transmittance and the degree of polarization before and after allowing it to stand in an atmosphere at 60° C. and 90% RH for 500 hours are 3% or less, respectively in terms of the absolute value as described in JPA No. 2001-116922. In particular, the change rate of the light transmittance is preferably 2% or less, and the change of the degree of polaization is preferably 1.0% or less, and more preferably 0.1% or less in terms of the absolute value. Also, as described in JPA No. hei 7-077608, it is preferable that the degree of polarization after allowing it to stand at 80° C. and 90% RH for 500 hours is 95% or more and that the tranittance ofthe single body is 38% or more.

(4-2) Dry Durability:

In the polarizing plate of the invention, it is preferable that change rates of the light transmittance and the degree of polarization before and after allowing it to stand at 80° C. in a dry atmosphere for 500 hours are 3% or less, respectively in terms ofthe absolute value. In particular, the change rate of the light transmittance is preferably 2% or less, and the change rate of the degree of polarization is preferably 1.0% or less, and more preferably 0.1% or less in terms of the absolute value.

(4-3) Other Durability:

Further, in the polarizing plate of the invention, the shrinkage rate after allowing it to stand at 80° C. for 2 hours can be preferably controlled at 0.5% or less as described in JPA No. hei 6-167611; the x value and y value after allowing a laminate of polarizing plates disposed in the cross-Nicole position on the both faces of a glass plate in an atmosphere at 69° C. for 750 hours can be preferably made to fall within the range as described in JPA No. hei 10-68818; and the change in a ratio of spectral intensities at 105 cm⁻¹ and 157 cm⁻¹ by the Raman spectroscopy after allowing it to stand in an atmosphere at 80° C. and 90% RH for 200 hours can be preferably made to fall within the ranges as described in JPA No. hei 8-094834 and JPA No. hei 9-197127.

(5) Degree of Alignment:

When the degree of alignment of PVA is high, a good polarization performance is obtained. However, an order parameter value as calculated by means such as polarized Raman scattering and polarized FT-IR is preferably in the range of from 0.2 to 1.0. Also, a difference between the alignment coefficient of polymer segments in all the amorphous regions of the polarizer and the alignment coefficient (0.75 or more) of dye molecules can be preferably controlled to be at least 0.15 as described in JPA No. syo 59-133509; and the alignment coefficient of the amorphous region of the polarizer can be preferably controlled at from 0.65 to 0.85 as described in JPA No. hei 4-204907; and the alignment coefficient of a high-order iodine ion such as I₃ and I₅ can be preferably controlled at from 0.8 to 1.0 in terms of an order parameter value.

(6) Other Characteristics:

In the polarizing plate of the invention, the shrinkage force per unit width in the direction of the absorption axis can be preferably controlled at 4.0 N/cm or less when heated at 80° C. for 30 minutes as described in JPA No. 2002-6133; in the case of allowing the polarizing plate to stand under a heating condition of 70° C. for 120 hours, the dimensional change rate in the direction of the absorption axis of the polarizer and the dimensional change rate in the direction of the polarization axis can be preferably made to fall within ±0.6%, respectively as described in JPA No. 2002-236213; and the water content of the polarizing plate can be preferably controlled at 3% by weight or less as described in JPA No. 2002-90546. Further, the surface roughness in the direction perpendicular to the stretching axis can be preferably controlled at 0.04 μm or less in terms of a center line average surface roughness as described in JPA No. 2000-249832; the refractive index no in the direction of the transmission axis can be preferably controlled at more than 1.6 as described in JPA No. hei 10-268294; and the relationship between the thickness of the polarizing plate and the thickness of the protective film can be preferably made to fall within the range as described in JPA No. hei 10-11411.

4. Functionalization of Polarizing Plate:

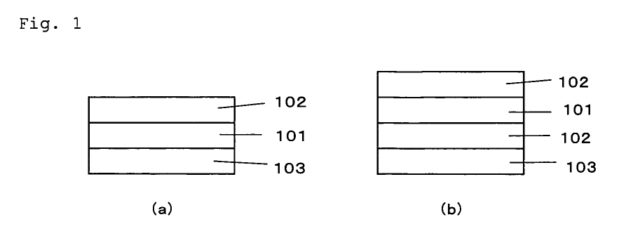

The polarizing plate of the invention is preferably used as a functionalized polarizing plate integrated with a functional optical film having a functional layer such as a wide viewing angle film of LCD, a λ/4 plate for applying to a reflection type LCD, an antireflection film for improving the visibility of display, a luminance enhancing film, a hard coat layer, a front scattering layer, and an anti-glare layer. A constructive example of the polarizing plate of the invention having the foregoing functional optical film integrated therewith was shown in FIG. 1. A polarizing plate as shown in FIG. 1(a) has a protective film 102 on one surface of a polarizer 101 and a functional optical film 103 on the other surface. In this way, the functional optical film 103 maybe bonded as a protective film on the surface of the polarizer 101 using an adhesive. Also, in a polarizing plate as shown in FIG. 1(b), the functional optical film 103 may be bonded on a polarizing plate having the protective film 102 on the both faces of the polarize 101. In the case of the former, an arbitrary transparent protective film can be used as the protective film of the other side. Incidentally, in FIG. 1, an adhesive layer made of an adhesive, which is provided between the respective layers was omitted. It is also preferred to control the peel strength between the respective layers such as the functional layer and the protective film at 4.0 N/25 mm or more as described in JPA No.2002-311238. It is preferable that the functional optical film is disposed in the liquid crystal module side or the side opposite to the liquid crystal module, namely in the display side or the backlight side depending upon the desired function.

The functional optical film which is used upon being integrated with the polarizing plate of the invention will be described below.

(1) Wide Viewing Angle Film:

The polarizing plate of the invention can be used in combination with a wide viewing angle film as proposed in the display mode such as TN (Twisted Nematic), IPS In-Plane Switching), OCB (Optically Compensatory Bend), VA Vertically Aligned), and ECB (Electrically Controlled Birefringence).

As the wide viewing angle film for TN mode, it is preferred to use a combination with WV Film (manufactured by Fuji Photo Film Co., Ltd.) as described in Nihon Insatsu Gakkaishi (Bulletin of the Japanese Society of Printing Science and Technology), Vol. 36, No. 3 (1999), pp. 40-44, Monthly Display, August (2002), pp. 20-24, JPA No. hei 4-229828, JPA No. hei 6-75115, JPA No. hei 6-214116, JPA No. hei 8-50206, etc.

A preferred construction of the wide viewing angle film for TN mode is one in which an alignment layer and an optically anisotropic layer are provided in this order on the foregoing transparent polymer film. Though the wide viewing angle film may be laminated on the polarizing plate via an adhesive and used, it is especially preferable from the viewpoint of thinning that the wide viewing angle film is used while serving as one of the protective films of the foregoing polarizer as described in SID '00 Dig., p. 551 (2000).

The alignment layer can be provided by means such as a rubbing treatment of an organic compound (preferably a polymer), oblique vapor deposition of an inorganic compound, and formation of a micro group-containing layer. Further, though an alignment layer which generates an alignment function by imparting an electric field, imparting a magnetic field or irradiating light, an alignment layer formed by a rubbing treatment of a polymer is especially preferable. The rubbing treatment is preferably performed by rubbing the surface of a polymer layer by paper or a cloth several times in the fixed direction. It is preferable that the direction of the absorption axis of the polarizer and the rubbing direction are substantially parallel to each other. With respect to the kind of the polymer to be used in the alignment layer, polyimides, polyvinyl alcohol, polymers having a polymerizable group as described in JPA No. hei 9-152509, and the like can be preferably used. The thickness of the alignment layer is preferably from 0.01 to 5 μm, and more preferably from 0.05 to 2 μm.

It is preferable that the optically anisotropic layer contains a liquid crystalline compound. It is especially preferable that the liquid crystalline compound which is used in the invention contains a discotic compound (discotic liquid crystal). As the discotic liquid crystal molecule, a triphenylene derivative represented by the following D-1 is preferable, namely a compound having a disc-like core portion from which side chains radially extend is preferable. Also, in order to impart stability with time, it is preferred to further introduce a group which is reactive with heat, light, etc. Preferred examples of the foregoing discotic liquid crystal are described in JPA No. hei 8-50206.

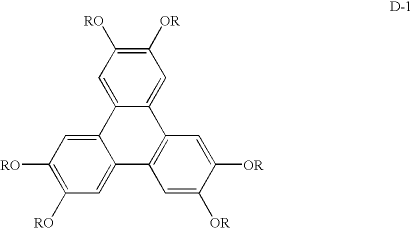

The discotic liquid crystal molecules may align substantially in parallel to the film plane with a pretilt angle in the rubbing direction in the vicinity of the alignment layer, whereas the discotic liquid crystal molecules may stand and align closely vertically against the plane in the opposite air face side. The whole of the discotic liquid crystal layer takes hybrid alignment, and the wide viewing angle of TFT-LCD of TN mode can be realized by this layer structure.

In general, the foregoing optically anisotropic layer is obtained by coating a solution of a discotic compound and other compound (additionally, for example, a polymerizable monomer and a photopolymerization initiator) dissolved in a solvent on the alignment layer, drying, subsequently heating to the discotic nematic phase forming temperature, polymerizing upon irradiation with UV light, etc., and additionally cooling. The discotic nematic liquid crystal phase-solid phase transition temperature of the discotic liquid crystalline compound which is used in the invention is preferably from 70 to 300° C., and especially preferably from 70 to 170° C.

Also, as the compound other than the discotic compound, which is added to the foregoing optically anisotropic layer, any compound can be used so far as it is compatible with the discotic compound and is able to impart a preferred change of the tilt angle to the liquid crystalline discotic compound, or it does not hinder the alignment. Of these, additives for alignment control in the air interface side such as polymerizable monomers (for example, compounds having a vinyl group, a vinyloxy group, an acryloyl group, or a metacryloyl group) and fluorine-containing triazine compounds and polymers such as cellulose acetate, cellulose acetate propionate, hydroxypropyl cellulose, and cellulose acetate butyrate can be used. These compounds are generally used in the addition amount of from 0.1 to 50% by weight, and preferably from 0.1 to 30% by weight with repect to the discotic compound.

The thickness of the optically anisotropic layer is preferably from 0.1 to 10 μm, and more preferably from 0.5 to 5 μm.

A preferred embodiment of the wide viewing angle film of the invention is an embodiment in which the wide viewing angle film is constructed of a protective film made of a thermoplastic saturated alicyclic structure-containing polymer as the transparent substrate film, an alignment layer to be provided thereon, and an optically anisotropic layer made of a discotic liquid crystal to be formed on the subject alignment layer, and the optically anisotropic layer is crosslinked upon irradiation with UV light.

Also, besides, in the case of combining the wide viewing angle film with the polarizing plate of the invention, the wide viewing angle film can be preferably laminated with a phase difference plate having an optical axis in the direction intersecting with a plate face and showing anisotropy in birefringence as described in JPA No. hei 07-198942; and the rates of dimensional change of the protective film and the optically anisotropic layer can be preferably made substantially equal to each other as described in JPA No.2002-258052. Also, the water content of the polarizing plate to be laminated with the wide viewing angle film can be preferably controlled at 2.4% or less as described in JPA No. 2000-258632; and the contact angle of the surface of the wide viewing angle film against water can be preferably controlled at 70° or less as described in JPA No. 2002-267839.

The wide viewing angle film for a liquid crystal cell of IPS mode is used for optical compensation of liquid crystal molecules aligned in parallel to the substrate face and enhancement of the viewing angle characteristic of the cross transmittance of the polarizing plate at the time of black display in the non-applied state of an electrical field. The IPS mode becomes black display in the non-applied state of an electrical field, and the transmission axes of a pair of vertical polarizing plates cross at right angles each other. However, in the case of observing obliquely, the cross angle between the transmission axes is not 90°, and leaked light is generated, whereby the contrast is lowered. In the case where the polarizing plate of the invention is used in a liquid crystal cell of IPS mode, in order to lower the leaked light, the polarizing plate is preferably used in combination with a wide viewing angle film having an in-plane phase difference close to 0 and having a phase difference in the thickness direction as described in JPA No. hei 10-54982.

The wide viewing angle film for a liquid crystal cell of OCB mode is used for the purposes of performing vertical alignment in the center portion of the liquid crystal layer by applying an electrical field and optically compensating the liquid crystal layer obliquely aligned in the vicinity of the interface of the substrate, thereby improving the viewing angle char i c of black display. In the case where the polarizing plate of the invention is used in a liquid crystal cell of OCB mode, the polarizing plate is preferably used in combination with a wide viewing angle film resulting from hybrid alignment of a disc-like liquid crystalline compound as described in U.S. Pat. No. 5,805,253.

The wide viewing angle film for a liquid crystal cell of VA mode improves the viewing angle characteristic of black display in the state that liquid crystal molecules in the non-applied state of an electrical field align vertically against the substrate face. Such a wide viewing angle film is preferably used in combination with a film having an in-plane phase difference close to 0 and having a phase difference in the thickness direction, a film in which disc-like compounds are aligned in parallel to a substrate, a film in which stretched films having the same in-plane retardation value are laminated and disposed such that the slow axes are crossed, or a laminate with a film made of a rod-like compound such as liquid crystal molecules for the purpose of preventing deterioration of the cross transmittance in the oblique direction of the polarizing plate as described in Japanese Patent No. 2,866,372.

(2) λ/4 Plate:

The polarizing plate of the invention can be used as a circularly polarizing plate laminated with λ/4 plate. The circularly polarizing plate has a function to convert incident light into circularly polarized light and is preferably utilized for reflection type liquid crystal display devices, semi-transmission type liquid crystal display devices such as ECB mode, or organic EL elements, etc.

In order to obtain substantially complete circularly polarized light within the visible light wavelength range, the λ/4 plate which can be used in the invention is preferably a phase difference film having a retardation (Re) of substantially 1/4 of the wavelength within the visible light wavelength range. The term “retardation of substantially 1/4 within the visible light wavelength range” means that the longer the wavelength, the larger the retardation in the wavelength of from 400 to 700 nm and shows the range which is satisfactory with the relationship that a retardation value as measured at a wavelength of 450 nm (Re50) is from 80 to 125 nm, and a retardation value as measured at a wavelength of 590 nm (Re590) is from 120 to 160 nm. (Re590−Re450)≧5 nm is more preferable, and (Re590−Re450)≧10 nm is especially preferable.

The λ/4 plate which can be used in the invention is not particularly limited so far as the foregoing condition is satisfied. For example, known λ/4 plates such as λ/4 plates made of a laminate of plural polymer films as described in JPA No. hei 5-27118, JPA No. hei 10-68816, and JPA No. hei 10-90521; λ/4 plates resulting from stretching a single polymer sheet as described in WO 00/65384 and WO 00/26705; and λ/4 plates made of a polymer film having at least one optically anisotropic layer provided thereon as described JPA No. 2000-284126 and JPA No. 2002-31717 can be used. Also, the direction of the slow axis of the polymer film and the alignment direction of the optically anisotropic layer can be disposed in an arbitrary direction adaptive with the liquid crystal cell.

In the circularly polarizing plate, though the slow axis of the λ/4 plate and the transmission axis of the foregoing polarizer can be intersected with each other at an arbitrary angle, they are preferably intersected with each other at an angle falling within the range of 45°±20°. However, the slow axis of the λ/4 plate and the transmission axis of the foregoing polarizer may be intersected with each other at an angle falling outside the foregoing range.

In the case where the λ/4 plate is constructed of a laminate of a λ/4 plate and a λ/2 plate, it is preferred to perform the lamination in such a manner that angles of the in-plane slow axes of the λ/4 plate and the α/2 plate against the transmission axis of the polarizing plate are substantially 75° and 15°, respectively as described in Japanese Patent No. 3,236,306 and JPA No. hei 1 -68816.

(3) Antireflection Film:

The polarizing plate of the invention can be used in combination with an antireflection film. As the antireflection thin, all of films having a reflectance of approximately 1.5%, which are provided merely with a single layer made of a low refractive index raw material such as a fluorine based polymer, and films having a reflectance of 1% or less, which utize multi-layered interference of a thin film, can be used. In the invention, a construction in which a low refractive index layer and at least one layer having a refractive index higher than that of the low refractive index layer (i.e., a high refractive index layer or an intermediate refractive index layer) on a transparent support is preferably employed. Also, antireflection films as described in Nitto Giho (Nitto Technical Report), Vol. 38, No. 1, May, 2000, pp. 26-28 and JPA No. 2002-301783 can be preferably used.

The refractive index of each of the layers is satisfactory with the following relationship.

(Refractive index of high refractive index layer)>(Refractive index of intermediate refractive index layer)>(Refractive index of transparent support)>(Refractive index of low refractive index layer)

As the transparent support which is used in the antireflection film, the foregoing alicyclic structure-containing polymer protective films which are used for the protective layer of the polarizing layer can be preferably used.

The refractive index of the low refractive index layer is from 1.20 to 1.55, and preferably from 1.30 to 1.50. It is preferable that the low refractive index layer is used as an outermost layer having scratch resistance and stain resistance. For the purpose of enhancing the scratch resistance, it is preferably performed to use a raw material containing a silicone group or fluorine, thereby imparting slipperiness to the surface.

As the fluorine-containing compound, compounds described in, for example, paragraph Nos. [0018] to {0026} of JPA No. hei 9-222503, paragraph Nos. [0019] to [0030] of JPA No. hei. 11-38202, paragraph Nos. [0027] to [0028] of JPA No. 200140284, and JPA No. 2000-284102 can be preferably used.

As the silicone-containing compound, compounds having a polysiloxane structure are preferable, but reactive silicones (for example, SILAPLANE (manufactured by Chisso Corporation), polysiloxanes containing a silanol group at the both ends thereof (JPA No. hei 11-258403), and so on can also be used. An organometallic compound such as silane coupling agents and a specific fluorine-containing hydrocarbon group-containing silane coupling agent may be cured by a condensation reaction in the co-presence of a catalyst (for example, compounds described in JPA No. syo 58-142958, JPA No. syo 58-147483, JPA No. syo 58-147484, JPA No. hei 9-157582, JPA No. hei 11-106704, JPA No. 2000-117902, JPA No. 2001-48590, and JPA No. 2002-53804).

In the low refractive index layer, a filler (for example, low refractive index inorganic compounds having a mean particle size of primary particles of from 1 to 150 nm, such as silicon dioxide (silica) and fluorine-containing particles (for example, magnesium fluoride, calcium fluoride, and barium fluoride), and organic fine particles described in paragraph Nos. [0020] to [0038] of JPA No. hei 11-3820), a silane coupling agent, a slipping agent, a surfactant, and the like can be preferably contained as additives other than those described previously.

Though the low refractive index layer may be formed by a vapor phase process (for example, a vacuum vapor deposition process, a sputtering process, an ion plating process, and a plasma CVD process), it is preferable that the low refractive index layer is formed by a coating process because it can be cheaply produced. As the coating process, a dip coating process, an air knife coating process, a curtain coating process, a roll coating process, a wire bar coating process, a gravure coating process, and a micro gravure process can be preferably employed.

The film thickness of the low refractive index layer is preferably from 30 to 200 nm, more preferably from 50 to 150 nm, and most preferably from 60 to 120 nm.

The intermediate refractive index layer and the high refractive index layer are preferably each constructed such that ultra-fine particles of a high refractive index inorganic compound having a mean particle size of 100 nm or less are dispersed in a material for matrix. As the ultra-fine particles of a high refractive index inorganic compound, inorganic compounds having a refractive index of 1.65 or more, such as oxides of Ti, Zn, Sb, Sn, Zr, Ce, Ta, La, In, etc. and composite oxides containing such a metal atom can be preferably used.

Such ultra-fine particles can be used in an embodiment such as a treatment of the particle surface with a surface treating agent (for example, silane coupling agents described in JPA No. hei 11-295503, JPA No. hei 11-153703, and JPA No. 2000-9908 and anionic compounds or organometallic coupling agents described in JPA No. 2001-310432), employment of a core-shell structure in which a high refractive index particle is used as a core (JPA No. 2001-166104, etc.), joint use with a specific dispersant (for example, JPA No. hei 11-153703, U.S. Pat. No. 6,210,858B1, and JPA No. 2002-277609).

As the material for matrix, though conventionally known thermoplastic resins, curable resin films, and the like can be used, functional materials described in JPA No. 2000-47004, JPA No. 2001-315242, JPA No. 2001-31871, JPA No. 2001-296401, etc. and curable films obtained from a metal alkoxide composition described in JPA No. 2001-293818 can also be used. The refractive index of the high refractive index layer is preferably from 1.70 to 2.20. The thickness of the high refractive index layer is from 5 nm to 10 pun, and more preferably from 10 nm to 1 μm. The refractive index of the intermediate refractive index layer is adjusted such that it becomes a value between the refractive index of the low refractive index layer and the refractive index of the high refractive index layer. The refractive index of the intermediate refractive index layer is preferably from 1.50 to 1.70.

The haze of the antireflection film is preferably 5% or less, and more preferably 3% or less. Also, the strength ofthe film is preferably H or more, more preferably 2H or more, and most preferably 3H or more by the pencil hardness test according to JIS K5400.

(4) Luminance Enhancing Film:

The polarizing plate of the invention can be used in combination with a luminance enhancing film. The luminance enhancing film has a function to decompose circularly polarized light or linearly polarize light, is disposed between the polarizing plate and the backlight, and backward reflects or backward scar the one-sided circularly polarized light or linearly polarized light in the backlight side. When the re-reflected light from the backlight portion partially changes the polarized state and again enters the luminance enhancing film and the polarizing plate, it partly transmits theretough. Accordingly, by repeating this step, the rate of utilization of light is enhanced, whereby the front luminance is enhanced by approximately 1.4 times. With respect to the luminance enhancing film, an anisotropic reflection system and an anisotropic scattering system are known, and all of them can be combined with the polarizing plate of the invention.

With respect to the anisotropic reflection system, luminance enhancing films having anisotropy between the reflectance and the transmittance by multiplexly laminating a uniaially stretched film and a non-stretched film, thereby enlarging a difference of the refractive index in the stretching direction are known, and a multilayered film system using the principles of dielectric mirror (as described in WO 95/17691, WO 95/17692, and WO 95/17699) and a cholesteric liquid crystal system (as described in European Patent No. 606940A2 and JPA No. hei 8-271731) are known. In the invention, DBEF-E, DBEF-D and DBEF-M (all of which are manufactured by 3M) are preferably used as the luminance enhancing film of the multilayered system using the principles of dielectric mirror, and NIPOCS (manufactured by Nitto Denko Corporation) is preferably as the luminance enhancing film of the cholesteric liquid crystal system. With respect to NIPOCS, Nitto Giho (ditto Technical Report), Vol. 38, No. 1, May, 2000, pp. 19-21 and the like can be made hereof by reference.

Also, in the invention, it is preferred to use the luminance enhancing film of the anisotropic reflection system in combination with a luminance enhancing film of the anisotropic scattering system prepared by blending a positive intrinsic birefringent polymer and a negative intrinsic birefringent polymer and uniaxially stretching the blend as described in WO 97/32223, WO 97/32224, WO97/32225, WO 97/32226, JPA No. hei 9-274108, and JPA No. hei 11-174231. As the luminance enhancing film of the anisotropic scattering system, DRPF-H (manufactured by 3M) is preferable.

With respect to the polarizing plate of the invention and the luminance enhancing film, an embodiment in which the both are laminated via an adhesive, or an integrated body in one of the protective films of the polarizing plate is made as the luminance enhancing film is preferable.

(5) Other functional Optical Films:

It is also preferred to use the polarizing plate of the invention in combination with a functional optical film provided with a hard coat layer, a front scattering layer, an anti-glare layer, a gas barrier layer, a slipping layer, an antistatic layer, an undercoat layer, a protective layer, etc. Also, it is preferable that these functional layers are integrated with each other or within the same layer as the foregoing antireflection layer and optically anisotropic layer, etc. and used.

(5-1) Hard Coat Layer:

In the polarizing plate of the invention, for the purpose of imparting a dynamic strength such as scratch resistance, it is preferred to combine a hard coat layer with a functional optical film provided on the surface of a transparent support. In the case where a hard coated layer is applied to the foregoing antireflection film and used, it is especially preferred to provide the hard coat layer between the transparent support and the high refractive index layer.

It is preferable that the hard coat layer is formed by a crosslinking reaction or polymerization reaction of a curable compound by light and/or heat. A curable functional group is preferably a photopolymerizable functional group, and an organometallic compound containing a hydrolyzable functional group is preferably an organic alkoxysilyl compound. As the specific constructive composition of the hard coat layer, ones described in, for example, JPA No. 2002-144913, JPA No. 2000-9908, and WO 00/46617 can be preferably used.

The film thickness of the hard coat layer is preferably from 0.2 to 100 μm. The strength of the hard coat layer is preferably H or more, more preferably 2H or more, and most preferably 3H or more by the pencil hardness test according to JIS K5400. Also, it is preferable that the abrasion loss of a specimen before and after the Taber test according to JIS K5400 is as small as possible.

As the material which forms the hard coat layer, ethylenically unsampled group-containing compounds and ring-opening polymerize group-containing compounds can be used. These compounds can be used singly or in combinations. As preferred examples of the ethylenically unsaturated group-containing compounds, compounds, for example, polyacrylates of a polyol such as ethylene glycol diacrylate, trimethylolpropane triacrylate, ditrimethylolpropane tetraacrylate, pentaerythritol triacrylate, pentaerythritol tetraacaylate, dipentaerythritol pentaacrylate, and dipentaerythritol hexaacrylate; epoxy acrylates such as diacrylate of bisphenol A diglycidyl ether and diacrylate of hexanediol diglycidyl ether, and uretane acrylates obtained by reaction of a polyisocyanate and a hydroxyl group-containing acrylate such as hydroxyethyl acrylate can be enumerated. Also, as commercially available compounds, EB600, EB-40, EB-140, EB-1150, EB-1290K, IRR214, EB-2220, TMPTA and TMPTMA (all of which are manufactured by DAICEL-UCB Company Ltd.), UV-6300 and UV-1700B (all of which are manufactured by Nippon Synthetic Chemical Industry Co., Ltd.), and the like are enumerated.

Also, preferred examples of the ring-opening polymerizable group-containing compounds include glycidyl ethers such as ethylene glycol diglycidyl ether, bisphenol A diglycidyl ether, trimethylolethane triglycidyl ether, trimethylolpropane triglycidyl ether, glycerol triglycidyl ether, triglycidyl trishydroxyethyl isocyanurate, sorbitol tetraglycidyl ether, pentaerytritol tetraycidyl ether, polyglycidyl ether of a cresol novolak resin, and polyglycidyl ether of a phenol novolak resin; alicyclic epoxys such as CELLOXIDE 2021P, CELLOXIDE 2081, EPOLEAD GT-301, EPOLEAD GT-401 and EHPE 3150CE (all of which are manufactured by Daicel Chemical Industries, Ltd.) and polycyclohexyl epoxy methyl ether of a phenol novolak resin; and oxetanes such as OXT-121, OXT-221, OX-SQ and PNOX-1009 (all of which are manufactured by Toagosei Co., Ltd.). Besides, a polymer of glycidyl (meth)acrylate or a copolymer thereof with a monomer which is copolymerizable with glycidyl (meth)acrylate can be used in the hard coat layer.

For the purposes of reducing cure shrinkage of the hard coat layer, enhancing adhesiveness to a substrate, and lowering curl of the hard coat treated article of the invention, it is possible to preferably add crosslinked fine particles, for example, fine particles of oxides of silicon, titanium, zirconium, aluminum, etc., and organic fine particles such as crosslinked particles of polyethylene, polystyrene, poly(meth)acrylic esters, polydimethylsiloxane, etc. and crosslinked rubber fine particles of SBR, NBR, etc. The mean particle size of these crosslinked fine particles is preferably from 1 nm to 20,000 nm. Also, with respect to the crosslinked fine particles, any shape including spherical, rod-like, acicular, and plate-like shapes can be employed without particular limitations. The addition amount of the fine particles is preferably 60% by volume or less, and more preferably 40% by volume or less ofthe hard coat layer after curing.

In the case where the foregoing inorganic fine particles are added, since they are generally poor in compatibility with a binder polymer, it is preferred to perform a surface treatment using a surface treating agent containing a metal such as silicon, aluminum, and titanium and having a functional group such as an alkoxide group, a carboxyl group, a sulfonic group, and a phosphonic group.

It is preferable that the hard coat layer is cured by heat or using active energy rays. Above all, active energy rays such as radiations, gamma rays, alpha rays, electron beams, and ultraviolet light are preferably used. Taking into consideration safety and productivity, electron beams and ultraviolet light are especially preferable for use. In the case of performing curing by heat, taking into consideration heat resistance of the plastic itself, the heating temperature is preferably 140° C. or lower, and more preferably 100° C. or lower.

(5-2) Front Scattering Layer:

The front scattering layer is used for the purpose of improving a viewing angle characteristic (hue and luminance distribution) in the longitudinal and lateral directions in applying the polaizing plate of the invention to a liquid crystal display device. In the invention, a construction in which fine particles having a different refractive index are dispersed in a binder is preferable. For examples, a construction in which the front scattering coefficient is specified as described in JPA No. hei 11-38208; a construction in which a relative refractive index of a transparent resin and a fine particle is made to fall within the a specified range as described in JPA No. 2000-199809; and a construction in which the haze value is defined to be 40% or more as described in JPA No. 2002-107512 can be employed. Also, for the purpose of controlling the haze viewing angle characteristic of the polarizing plate of the invention, it is possible to preferably use a combination with “LUMISTY” described in Photo-Functional Films, pages 31 to 39, which is a technical report of Sumitomo Chemical Co., Ltd.

(5-3) Anti-Glare Layer:

The anti-glare layer is used for the purpose of scattering reflected light, thereby preventing reflection. The anti-glare function is obtained by forming projections and recesses on the most superficial surface (displace side) of the liquid crystal display device. The haze of the optical film having an anti-glare function is preferably from 3 to 30%, more preferably from 5 to 20%, and most preferably from 7 to 20%.

As the method of forming projections and recesses on the filn surface, for example, a method of adding fine particles, thereby forming projections and recesses on the film surface (for example, JPA No. 2000-271878); a method of adding a small amount (from 0.1 to 50% by weight) of relatively large particles (particle size: from 0.05 to 2 μm), thereby forming a surface projecting and recessing film (for example, JPA No. 2000-281410, JPA No. 2000-95893, JPA No. 2001-100004, and JPA No. 2001-281407); and a method of physically transferring a protecting and recessing shape onto the film surface (for example, an embossing method described in JPA No. syo 63-278839, JPA No. hei 11-183710, and JPA No. 2000-275401) can be preferably employed.

Such a functional layer can be provided on either one face of the polarizing side or opposite side to the polarizing side or on the both faces and used.

5. Liquid Crystal Display Device Using Polarizing Plate:

Next a liquid crystal display device in which the polarizing plate of the invention can be used will be described below

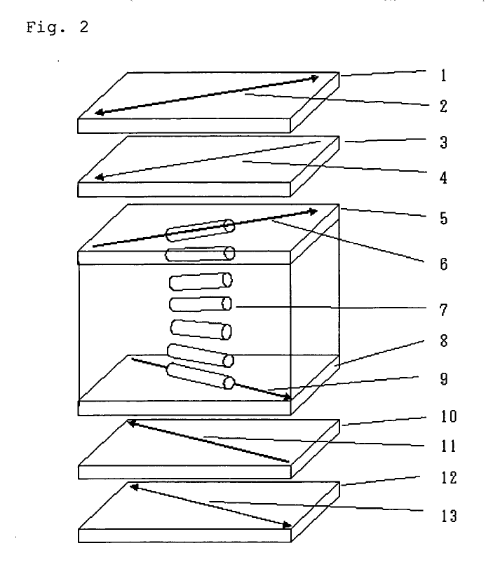

FIG. 2 is one example of a liquid crystal display device in which the polarizing plate of the invention is used.

A liquid crystal display device shown in FIG. 2 has a liquid crystal cell (5 to 9) and an upper polarizing plate 1 and a lower polarizing plate 12 disposed while interposing the liquid crystal cell (5 to 9) therebetween. The polarizing plate is interposed by a polarizer and a pair of transparent protective films. In FIG. 2, the polarizing plate is shown as an integrated polarizing plate, and the detailed structure thereof is omitted. The liquid crystal cell is constructed of an upper substrate 5 and a lower substrate 8 and a liquid crystal layer formed of a liquid cl molecule 7 interposed therebetween. A liquid crystal cell is classified into display modes such as TN (Twisted Nematic), EPS (In-Plane Switching), OCB (Optically Compensatory Bend), VA Vertically Aligned), and ECB Electrically Controlled Birefringence) depending upon a difference of the alignment state of a liquid crystal molecule which undergoes an ON/OFF display. However, these polarizing plate of the invention can be used in any of the display modes regardless of a transmission type or a reflection type.

An alignment film (not shown) is formed on each of the surfaces of the substrates 5 and 8 which bring into contact with the liquid crystal molecule 7 (the surface will be hereinafter sometimes referred to as “internal surface”), and the alignment of the liquid crystal molecule 7 in the non-applied state or lowly applied state of an electrical field is controlled by means of a rubbing treatment to be applied on the alignment film. Also, a transparent electrode (not shown) capable of applying an electrical filed to the liquid crystal layer made of the liquid crystal molecule 7 is formed on each of the internal surfaces of the substrates 5 and 8.

The rubbing direction of the TN mode is applied in the direction crossing to each by the upper and lower substrates, whereby the size of a tilt angle can be controlled by its strength, the number of rubbing, and the like. The alignment film is formed by coating a polyimide film and then baking. The size of a twist angle of the liquid crystal layer is determined by an intersecting angle in the rubbing direction of the upper and lower substrates and a chiral agent to be added to the liquid crystal material. Here, a chiral agent having a pitch of approximately 60 μm was added such that the twist angle became 90°.

Incidentally, in the case of a notebook personal computer, a monitor of personal computer, or a liquid crystal display device for television receiver, the twist angle is set up in the vicinity of 90° (from 85 to 95°); and in the case of a reflection type display device of mobile telephone, etc., the twist angle is set up at from 0 to 70°. Also, in the EPS mode or ECB mode, the twist angle becomes 0°. In the IPS mode, electrodes are disposed only on the lower substrate 8, and an electrical field which is in parallel to the substrate face is applied. Also, in the OCB mode, the twist angle is not provided, and the tilt angle is made large; and in the VA mode, the liquid crystal molecule 7 is aligned vertically against the upper and lower substrates.

Here, the size of Δnd which is the product of a thickness d of the liquid crystal layer and a refractive index anisotropy Δn changes the brightness at the time of white display. For that reason, in order to obtain the maximum brightness, its range is set up for every the display mode.

By performing lamination such that an intersecting angle between an absorption axis 2 of the upper polarizing plate 1 and an absorption axis 13 of the lower polarizing plate 12 is in general made approximately crossed, a high contrast is obtained. Though an intersecting angle between the absorption axis 2 of the upper polarizing plate 1 of the liquid crystal cell and the rubbing direction of the upper substrate 5 varies depending upon the liquid crystal display mode, it is in general set up in parallel or vertically in the TN or IPS mode. In the OCB or ECB mode, in many cases, the intersecting angle is set up at 45°. However, its optimum value varies depending upon the respective display modes due to the color tone of display color or the adjustment of a viewing angle, and the intersecting angle is not limited to this range.

In the liquid crystal display device of FIG. 2, optically anisotropic layers 3 and 10 are disposed between the liquid crystal cell and the polarizing plates 1 and 12 for the purpose of mainly enlarging the viewing angle. The optically anisotropic layers 3 and 10 are layers formed of liquid crystalline compounds the alignment of which is controlled by alignment control directions 4 and 11 formed by, for example, a rubbing treatment, respectively. In correspondence with the mode of the liquid crystal cell, the alignment control directions 4 and 11 are optimized, and a preferred liquid crystal compound which is suited for the alignment is chosen. Incidentally, the material of the optically anisotropic layer is not limited to a liquid crystalline compound, but any material is employable. For example, a polymer film can be used as a substitute. In such case, the alignment control directions 4 and 11 can be adjusted by a condition of the stretching treatment and the like. For example, the optically anisotropic layers 3 and 10 are the same construction as in the foregoing wide viewing angle film (1) and λ/4 plate (2).

The liquid crystal display device in which the polarizing plate of the invention is used is not limited to the construction of FIG. 2 but may include other members. For example, a color filter may be disposed between the liquid crystal cell and the polarizer. Also, the both or one of the optically anisotropic layers 3 and 10 may not be provided. Also, the polarizing plates 1 and 13 and the optically anisotropic layers 3 and 10 may be disposed in the laminated state in which they are laminated with each other via an adhesive, or may be disposed as a so called integral elliptical polarizing plate in which one of the protective films in the liquid crystal cell side is used for viewing angle enlargement.

Also, in the case of use as a transmission type, a backlight using, as a light source, a cold cathode or hot cathode fluorescent tube or a light-emitting diode, a field emission element, or an electroluminescent element can be disposed on the back face. Also, the liquid crystal display device in which the polarizing plate of the invention is used may be of a reflection type. In such case, one sheet of the polarizing plate may be disposed in the observation side, and a reflection film is disposed on the back face of the liquid crystal cell or on the internal face of the lower substrate of the liquid crystal cell. As a matter of course, a front light using the foregoing light source may be provided in the observation side of the liquid crystal cell.

### EXAMPLES

### Example 1

### Preparation of Polarizing Plate A

### Example 1-1

### Preparation of Polarizer

An aqueous solution prepared by dissolving a PVA powder having an average degree of polymerization of 2,400 and a degree of hydrolysis of 99.9% or more in pure water so as to have a concentration of 12% by weight was coated on a polyester film, dried at 40° C. for 3 hours, and further dried at 110° C. for 60 minutes, thereby obtaining a PVA film having a thickness of 75 μm The resulting film was swollen by warm water at 30° C. for one minute and dipped in an aqueous solution of potassium iodide/iodine (weight ratio: 10/1) at 30° C. and uniaxially stretched two times in the longitudinal direction. The concentration of the aqueous solution of potassium iodide/iodine (weight ratio: 10/1) was adjusted such that the iodine concentration was 0.38% by weight. Subsequently, the film was uniaxially stretched in the longitudinal direction in a total stretch ratio of 7 times in a 4.25% boric acid aqueous solution at 52° C., washed with water by dipping in a water bath at 30° C., and then dried at 50° C. for 4 minutes, thereby obtaining a polarizer having a thickness of 26 μm.

The amount of boric acid in the obtained polarizer was measured with an inductively coupled plasma atomic emission spectrometer, and it was found the amount of boric acid in the obtained polarizer was 185 kg/m³.

### Example 1-2

### Protective Film

[Production of Raw Material for Protective Film]

In a reactor, 0.75 parts of 1-hexene, 0.18 parts of dibutyl ether and 0.46 parts of triisobutylaluminum were added to and mixed with 480 parts of dehydrated cyclohexane under a nitrogen atmosphere, to which were then continuously added for polymerization a norbornene based monomer mixture consisting of 78 parts of tricycle[4.3.0.12,5]deca-3,7-diene (dicyclopenta-diene, hereinafter abbreviated as “DCP”), 52 parts of 1,4-metano-1,4,4a,9a-tetrahydrofluorene (hereinafter abbreviated as “MTF”) and 68 parts of tetracyclo[4.4.0.12,5.17,10]-dodeca-3-ene (hereinafter abbreviated as “TCD”) and 41 parts of tungsten hexachloride (a 0.8% toluene solution) over 3 hours while keeping at 44° C. To the polymerization solution, 1.0 part of butyl glycidyl ether and 0.48 parts of isopropyl alcohol were added to inactivate the polymerization catalyst, thereby stopping the polymerization reaction.

Subsequently, 300 parts of cyclohexane was added to 100 parts of the resulting ring-opening polymer-containing reaction solution, to which was then added 5.2 parts of a nickel-alumina catalyst (manufactured by Nikki Chemical Co., Ltd.) as a hydrogenation catalyst. The system was pressurized to 5 MPa by hydrogen, heated to a temperature of 205° C. while stirring, and then allowed to react for 5 hours, thereby obtaining a reaction solution containing 20% of a DCP/MTF/TCD ring-opening polymer hydrogenated polymer. After removing the hydrogenation catalyst by filtration, a soft polymer (SEPTON 2002 manufactured by Kuraray Co., Ltd.) and an antioxidant (IRGANOX 1010 manufactured by Ciba Speciality Chemicals) were added in amounts of 0.1 parts, respectively based on 100 parts of the polymer to the resulting solution and dissolved therein. Subsequently, the hydrogenated polymer in the molten state was extruded in a strand form from an extruder while removing cyclohexane and other volatile components from the solution using a cylindrical concentration evaporator (manufactured by Hitachi, Ltd.), cooled and palletized for recovery. The copolymerization ratio of the respective norbornene based monomers in the polymer was calculated from the residual norbornene composition in the solution after the polymerization (by gas chromatography). As a result, the copolymerization ratio was found to be DCP/MTF/TCD =40/25/35, which was substantially equal to the composition as charged, and the content of a repeating unit not containing a norbornene ring structure was 64%. This ring-opening polymer hydrogenation product had a weight average molecular weight (Mw) of 34,000, a hydrogenation rate of 99.9%, and a Tg of 132° C.

[Surface Treatment]

The pellets obtained in Production Example 1 were dried at 70° C. for 2 hours using a hot air dryer through which air was passed, thereby removing the moisture. The resulting pellets were subjected to extrusion molding into a film (A) having a thickness of 40 μm using a T-die type film melt extrusion molding machine having a resin melt kneader equipped with a 65-mmφ screw under molding conditions of a molten resin temperature of 222° C. and a width of the T-die of 300 mm.

The film (A) had a water vapor transmission rate of 2.8 g/cm²·24 h and an in-plane maximum retardation value of 1.8 nm. The resulting film was cut into a size of 300 mm in the lengthwise direction and subjected to a glow discharge treatment between brass-made upper and lower electrodes (in an argon gas atmosphere) (a high-frequency voltage of 4,200 V having a frequency of 3,000 Hz was applied between the upper and lower electrodes, and the treatment was performed for 20 seconds), thereby preparing a protective film sample-1 for polarizing plate. A contact angle of the protective film surface having been subjected to a glow discharge treatment against pure water was 41°. The contact angle was measured by a contact angle meter CA-X Model manufactured by Kyowa Interface Science Co., Ltd.

[Lamination]

Thereafter, an aqueous solution containing 4% of PVA (PVA-124 manufactured by Kuraray Co., Ltd) and 0.5% of boric acid was coated as an adhesive on the surface-treated face of the protective film-1, thereby forming an adhesive layer. Two sheets of the protective film-1 having this adhesive layer on the surface thereof were respectively laminated on the both faces of a polarizer made of a PVA film at room temperature, and the laminate was further heated at 70° C. for 15 minutes, thereby preparing a polarizing plate A.

[Measurement of Single Plate Transmittance and Degree of Polarization]

The polarizing plate A was subjected to sample cutting into a size of 2×5 cm and measured for transmittance by Shimadzu Recording Spectrophotometer UV3100. The transmittance when the absorption axes of two sheets of the polarizing plate were made coincident and superimposed was defined as H0 (%), and the tranmittance when the absorption axes were crossed and superimposed was defined as H1 (%), and a degree of polariztion P (%) was determined according to the following expression.
P=[(H0−H1)/(H0+H1)]^{1/2}×100

Also, the single plate transmittance was determined using a sample of one sheet and subjecting the transmittance of from 350 to 780 nm to luminosity correction.

The polarizing plate A had a single plate transmittance of 43.1%, a degree of polaization of 99.98% and at nsrnittance at 410 nm of 0.16%.

### Example 2

### Preparation of Polarizing Plate B

A polarizing plate B was prepared in the same manner as in Example 1-1, except that ZEONOR NF16 (manufactured by ZEON Corporation, which is a film having a film thickness of 100 μm and made of a saturated alicyclic structure-containing thermoplastic resin) was used as the protective film and that the surface treatment was performed by a flame treatment at a combustion amount of 300 kcal/cmh for 0.1 seconds using a flame treatment device manufactured by Chugai Ro Co., Ltd. The contact angle of the surface of the protective film having been subjected to a surface treatment in this Example against pure water was 37°.

Also, the polarizing plate B had a single plate transmittance of 43.2%, a degree of polarization of 99.96% and at nsnittance at410 nm of 0.16%.

### Example 3

### Preparation of Polarizing Plate C

A polarizing plate C was prepared in the same manner as in Example 1-1, except that an ARTON film (manufactured by JSR Corporation, which is a film having a film thickness of 100 μm and made of a saturated alicyclic structure-containing thermoplastic resin) was used as the protective film and that the surface treatment was performed by subjecting the surface to a corona discharge treatment in air at a discharge amount of 100 W/m²·min. The contact angle of the surface of the protective film having been subjected to a surface treatment in this Example against pure water was 44°.

Also, the polarizing plate C had a single plate transmittance of 43.0% and a degree of polarization of 99.98%.

### Example 4

### Preparation of Polarizing Plate D

A polarizing plate D was prepared in the same manner as in Example 1, except that the composition of the adhesive was changed to an aqueous solution containing 3% of PVA (PVA-124), 3% of potassium iodide and 0.2% of boric acid.

The polarizing plate D had a single plate transmittance of 43.1%, a degree of polariation of 99.99% and at rlrnittance at 410 nm of 0.16%.

### Example 5

### Preparation of Polarizing Plate E

A polarizing plate E was prepared in the same manner as in Example 1, except that the composition of the adhesive was changed to an aqueous solution containing 4% of PVA (PVA-124).

The polarizing plate E had a single plate transmittance of 42.7%, a degree of polarization of 99.96% and atmnittance at 410 nm of 0.16%.

### Example 6

### Preparation of Polarizing Plate F

A polarizing plate F was prepared in the same manner as in Example 1, except that a polarizer was produced according to a process described below.

An aqueous solution prepared by dissolving a PVA powder having an average degree of polymerization of 2,400 and a degree of hydrolysis of 99.9% or more in pure water so as to have a concentration of 12% by weight was coated on a polyester film, dried at 40° C. for 3 hours, and further dried at 110° C. for 60 minutes, thereby obtaining a PVA film having a thickness of 75 μm. The resulting film was swollen by warm water at 30° C. for one minute and dipped in an aqueous solution of potassium iodide/iodine/boric acid (weight ratio: 10/1/3) at 30° C. and uniaxially stretched two times in the longitudinal direction. The concentration of the aqueous solution of potassium iodide/iodine (weight ratio: 10/1) was adjusted such that the iodine concentration was 0.38% by weight. Subsequently, the film was uniaxially strhed in the longitudinal direction in a total stretch ratio of 7 times in a 4.25% boric acid aqueous solution at 52° C., washed with water by dipping in a water bath at 30° C., and then dried at 50° C. for 4 minutes, thereby obtaining a polarizer having a thickness of 26 μm.

The amount of boric acid in the obtained polarizer was measured with an inductively coupled plasma atomic emission spectrometer, and it was found the amount of boric acid in the obtained polarizer was 220 kg/m³.

The polarizing plate F had a single plate transmittance of 43.0%, a degree of polarization of 99.98% and atrasmittance at 410 nm of 0.10%.

### Example 7

### Preparation of Polarizing Plate G (Comparative Example)

A polarizing plate G for comparison was prepared in the same manner as in Example 1, except that the surface treatment of the protective film was not performed. The contact angle of the surface of the protective film in this Example against pure water was 83°.

The polarizing plate F had a single plate transmittance of 42.8% and a degree of polarization of 99.97%.

### Example 8

### Adhesive Evaluation

An adhesive strength between the protective film made of a thermoplastic saturated alicyclic structure-containing polymer and the polarizer was measured according to a T-peel peeling tester (JIS Z0237).

These evaluation results are shown in the following Table 1.

TABLE 1

| | Adhesive strength (kg/25 mm) |
|---|---|
| Polarizing plate A | 7.3 |
| Polarizing plate B | 7.5 |
| Polarizing plate C | 7.0 |
| Polarizing plate D | 7.2 |
| Polarizing plate E | 4.8 |
| Polarizing plate F | 7.4 |
| Polarizing plate G | 1.9 |
| (for comparison) | |

From the results shown in Table 1, it has been noted that the polarizing plates A to F of the Examples are excellent in the adhesive strength compared with the polarizing plate G, which was produced for comparison.

### Example 9

### Evaluation of Light Leakage

On the both faces of a soda lime glass plate having a thickness of 1.2 mm, a length of 310 mm and a width of 234 mm, two sheets of each of the foregoing polarizing plates A to G having the same size as the glass plate were laminated by an acrylic adhesive using a potable laminator such that the stretching axis of the polarizing plate took an angle of 45° against the side of the glass plate and became in the cross-Nicole state. The laminated glass plates were respectively allowed to stand in the dry state at 60° C. for 17 hours or 50 hours, or in the state at 60° C. and at 90% RH for 17 hours or 50 hours; and observed on the backlight.

The light leakage was visually observed by lighting the backlight and placing the foregoing thermally treed polarizing plate on the backlight The light leakage was evaluated according to the following four grades.
\mathring{●}: Light leakage was not observed
◯: Light leakage was slightly observed on the edge of the four sides.
Δ: Light leakage was distinctly observed on the edge of the four sides.
×: Light leakage was observed to the vicinity of the center of the film.

The results are shown in Table 2.

TABLE 2

| | Evaluation of light leakage | | | |
|---|---|---|---|---|
| | In the dry state | | in the state at 50° C. | |
| | at 60° C. | | and at 90% RH | |
| | 17 hours | 50 hours | 17 hours | 50 hours |
| Polarizing plate A | ⊙ | ⊙ | ◯ | ◯ |
| Polarizing plate B | ⊙ | ⊙ | ◯ | ◯ |
| Polarizing plate C | ⊙ | ⊙ | ◯ | ◯ |
| Polarizing plate D | ⊙ | ⊙ | ◯ | ◯ |
| Polarizing plate E | Δ | Δ | Δ | Δ |
| Polarizing plate F | ⊙ | ⊙ | ◯ | ◯ |
| Polarizing plate G | X | X | X | X |
| (for comparison) | | | | |

From the results shown in Table 2, it was found that the polarizing plates A to F, which falls within the scope of the present invention, were less in the light leakage as compared with the polarizing plate G for comparison. Especially the polarizing pale F, in which the amount of boric acid per unit volume in the polarizer was not less than 200 kg/m and the transmittance at 410 nm in a cross-Nicole position was not higher than 0.14%, was less in color variation and gave no color unevenness and gave preferred color.

### Example 10

As a retardation film for a VA mode, cellulose acylate films were produced according to a process described below.

1. Production of Cellulose Acylate Film

(1) Cellulose Acylate

Various types of cellulose acylate having a acyl group with a certain substitution degree, shown in Table 3, were prepared respectively. Sulfuric acid (7.8 weight parts with respect to 100 weight parts of cellulose) as a catalyst and carboxylic acid as material of an acyl substituent were added to cellulose, and an acylation was carried out at 40° C. The types and the substituent degrees of the acyl substituents were decided depending on the types and amounts of carboxylic acids. Aging after the acylation was carried out at 40° C. The obtained cellulose acylates were washed with acetone to remove low-molecular weight components. In Table 3 shown below, the term “CAB” is an abbreviation for cellulose acetate butyrate, or, in other words, cellulose ester derivative having a acetate group and a butyryl group, the term of “CAP” is an abbreviation for cellulose acetate propionate, or, in other words, cellulose ester derivative having a acetate group and a propionyl group as an acyl group, and the term of “CTA” is an abbreviation for cellulose triacetate, or, in other words, cellulose ester derivative having a acetate group as an acyl group.

(2) Dissolution

Under string, cellulose acylate, a plasticizer and a retardation-controlling agent, shown in Table 3, were put and dissolved in a mixed solvent of dichloromethane and methanol (weight ratio of dichloromethane to methanol is 87/13) under heating so that the mass concentration of cotton was 15%. At the same time, one weight part of “Sumisorb 165F”, manufactured by Sumitomo Chemical Co., Ltd., with respect to 100 weight parts of cellulose acylate was put in the solution under stirring and heating. When UV absorbers were used, 0.375 weight parts of UV absorber B (“TINUVIN 327” manufactured by CIBA SPECIALTY CHEMICALS) and 0.75 weight parts of UV absorber C (TINUVIN 328” manufactured by CIBA SPECIALTY CHEMICALS) with respect to 100 weight parts of cellulose acylate were added to the solution.

Retardation-controlling agent Compound No. 1

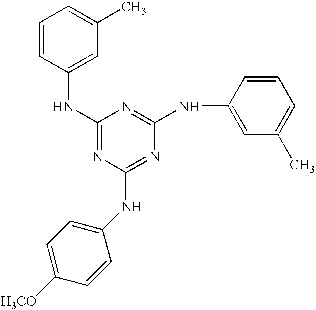

Retardation-controlling agent Compound No. 2

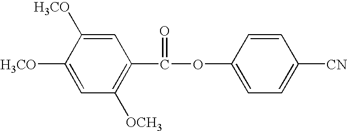

Retardation-controlling agent Compound No. 3

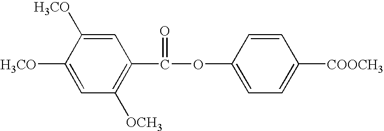

The obtained dopes were subjected to flow using a band flow casting machine. Films having a residual solvent content shown in Table 3 were longitudinally stretched using a tenter at a temperature shown in Table 3 by a magnitude of stretching shown in Table 3, then, were contracted by 20% and were dried at 125° C., to thereby produce cellulose acetate films having a thickness shown in Table 3 respectively. Thus-produced cellulose acetate films (optical compensation films) were subjected to measurement of the Re retardation value and Rth retardation value at 589 nm, using KOBRA21ADH (manufactured by Oji Scientific Instruments). It was found that all of obtained films had the variation of Re/Rth per 1% stretching ratio falling within the range from 0.011 to 0.016. It was also found that the film for comparison had the variation of 0.001.

It was found that all of obtained films had a coefficient of elasticity at 25° C. falling within the range from 150 kgf/mm² to 300 kgf/mm², a haze value failing within the range from 0.1 to 0.9 and a coefficient of photo-elasticity of not higher than 50×10⁻¹³ cm²/dyne. All of the obtained films contained a mat agent, “Sumisorb 165F” manufactured by Sumitomo Chemical Company, having a second mean particle diameter of not larger than 1.0 μm. It was also found that, after being left in the state at 80° C. and at 90% RH for 48 hours, all ofthe obtained films varied in mass with a ration falling within the range from 0 to 3%; and after being left in the state at 60° C. and at 95% RH and in the state at 90° C. and at 5% RH for 24 hours, all ofthe obtained films varied in size with a ration falling within the range from 0 to 4.5%.

| | | | | | | | | | Amount | | | Thick- | | |
|---|---|---|---|---|---|---|---|---|---|---|---|---|---|---|
| | Cellulose acylate | | | | | Plasti- | | | of | Stretching | Stretch- | ness | | |
| Sam- | | Ac group | Bu/Pr group | | Sum of | cizer | Retardation - | | residual | tem- | ing | after | Retardation | |
| ple | | Substitution | | Substituent | substituent | TPP/ | controlling agent | | solvent | perature | ratio | drying | Re | Rth |
| No. | Type | degree | Type | degree | degree | BDP | Type | Amount | (%) | (° C.) | (%) | (μm) | (nm) | (nm) |
| F1 | CAB | 0.9 | Bu | 1.8 | 2.7 | 5.8 | Compound | 6 | 30 | 130 | 15 | 80 | 32 | 140 |
| | | | | | | | No. 1 | | | | | | | |
| F2 | CAB | 0.9 | Bu | 1.8 | 2.7 | 11.7 | Compound | 4.5 | 30 | 130 | 25 | 92 | 40 | 130 |
| | | | | | | | No. 2 | | | | | | | |
| | | | | | | | Compound | 4.5 | | | | | | |
| | | | | | | | No. 3 | | | | | | | |
| F3 | CAP | 1.9 | Pr | 0.8 | 2.7 | 11.7 | Compound | 6 | 30 | 130 | 18 | 80 | 45 | 148 |
| | | | | | | | No. 1 | | | | | | | |
| F4 | CAP | 1.9 | Pr | 0.8 | 2.7 | 11.7 | Compound | 4.5 | 30 | 130 | 25 | 92 | 50 | 130 |
| | | | | | | | No. 2 | | | | | | | |
| | | | | | | | Compound | 4.5 | | | | | | |
| | | | | | | | No. 3 | | | | | | | |
| F5 | CTA | 2.87 | — | — | 2.87 | 11.7 | Compound | 3 | 25 | 140 | 32 | 92 | 32 | 135 |
| | | | | | | | No. 1 | | | | | | | |
| F6 | CTA | 2.87 | — | — | 2.87 | 11.7 | Compound | 3.5 | 25 | 140 | 25 | 92 | 40 | 140 |
| | | | | | | | No. 2 | | | | | | | |
| | | | | | | | Compound | 3.5 | | | | | | |
| | | | | | | | No. 3 | | | | | | | |
| F7 | CTA | 2.87 | — | — | 2.87 | 11.7 | Compound | 3 | 25 | 140 | 32 | 108 | 50 | 250 |
| | | | | | | | No. 1 | | | | | | | |
| F8 | CTA | 2.80 | — | — | 2.80 | 11.7 | Compound | 5.1 | 25 | 145 | 32 | 93 | 65 | 230 |
| | | | | | | | No. 1 | | | | | | | |
| F9 | CTA | 2.80 | — | — | 2.80 | 11.7 | Compound | 3.4 | 25 | 145 | 32 | 93 | 70 | 220 |
| | | | | | | | No. 1 | | | | | | | |
| | | | | | | | Compound | 2.6 | | | | | | |
| | | | | | | | No. 2 | | | | | | | |

### Example 11

### Production of Polarizing Plate

Polarizing plates were produced in the same manner as Example 6, except that cellulose acylate films shown in Table 3 were respectively used as one protective film. It was found that all of the obtained polarizing plates had a single plate transmittance falling within the range from 42.7 to 43.0%, a polarizing degree falling within the range from 99.97 to 99.98% and a transmittance at 410 nm of not higher than 0.13%.

### Example 12

### Evaluation of Light Leakage

A pair of polarizing plates and a pair of optical compensatory sheets were removed from a commercially available VA-mode liquid-crystal display (“AQOUS LC-20C5” manufactured by SHARP CORPORATION), employing a vertically-aligned type liquid-crystal cell. And in the place of them, polarizing plates produced in Example 10 were respectively bonded to the observer side and the backlight side of the liquid-crystal cells with an adhesive agent such that cellulose acylate films were disposed at the liquid-crystal cell sides. The transmission axes of the polarizing plates disposed at the observed side were along with vertical direction and the transmission axes of the polarizing plates disposed at the observed side were along with horizontal direction, or in other words, the polarizing plates were disposed in a cross-Nicole position. After being left in the dry sate at 60° C. for 50 hours or for 17 hours, or after being left in the sate at 60° C and at 90% RH for 50 hours or for 17 hours, the produced VA-mode liquid-crystal displays were observed.

The light leakages were visually observed by lighting the backlight. The light leakage was evaluated according to the four grades as well as Example 9. No light leakage was observed from the liquid crystal displays employing the polarizing plates.

Having described our invention as related to the present embodiments, it is our intention that the invention not be limited by any of the details of the description, unless otherwise specified, but rather be construed broadly within its spirit and scope as set out in the accompanying claims.

1. A polarizing plate comprising:
a polyvinyl alcohol based polarizer,
a protective film comprising a saturated alicyclic structure-containing thermoplastic polymer, and
an adhesive layer comprising a water-soluble polymer between the protective film and the polarizer
wherein the surface of the protective film contacting with the adhesive layer is subjected to a surface treatment.

2. The polarizing plate of claim 1, wherein a contact angle of the surface of the protective film contacting with the adhesive layer against water is less than 50°.

3. The polarizing plate of claim 1, wherein an amount of boric acid per unit volume in the polarizer is 200 kg/m³ or more.

4. The polarizing plate of claim 1, giving a transmittance of 0.14% or less at 410 nm when being disposed in a cross-Nicole position.

5. The polarizing plate of claim 1, wherein the water-soluble polymer is polyvinyl alcohol.

6. The polarizing plate of claim 1, wherein the adhesive layer is a layer formed of a composition comprising a water-soluble polymer and a hardener.

7. The polarizing plate of claim 1, further comprising a retardation layer disposed on an opposite surface of the polarizer.

8. The polarizing plate of claim 1, wherein the adhesive layer is a layer formed of a composition comprising at least one polyvinyl alcohol and a hardener.

9. The polarizing plate of claim 1, wherein the saturated alicyclic structure-containing thermoplastic polymer is a polymer produced by hydrogenating a ring-opening polymer of at least one norbornene based monomer.

10. The polarizing plate of claim 9, wherein the hydrogenation rate of the polymer is 90% or more.

11. The polarizing plate of claim 1, wherein the surface of the protective film contacting with the adhesive layer is subjected to a glow discharge treatment, a flame treatment or a corona discharge treatment.

12. A process for producing a polarizing plate comprising:
subjecting a surface of a film comprising a saturated alicyclic structure-containing thermoplastic polymer to a surface treatment; and
laminating the surface of the film having been subjected to a surface treatment and a surface of a polyvinyl alcohol based polarizer with an adhesive composition comprising a water-soluble polymer.

13. The process of claim 12, comprising applying the adhesive composition on the surface of the film having been subjected to a surface treatment, thereby forming an adhesive layer.

14. The process of claim 12, wherein the surface treatment is a glow discharge treatment a flame treatment or a corona discharge treatment.

15. The process of claim 12, wherein, as a result of the surface treatment a contact angle of the surface of the film against pure water becomes less than 50°.

16. The process of claim 12, wherein the water-soluble polymer is polyvinyl alcohol.

17. The process of claim 12, wherein the adhesive composition comprises at least one polyvinyl alcohol and a hardener.

18. The process of claim 12, wherein the saturated alicyclic structure-containing thermoplastic polymer is a polymer produced by hydrogenating a ring-opening polymer of at least one norbornene based monomer.

19. The process of claim 12, wherein the hydrogenation rate of the polymer is 90% or more.

20. The process of claim 12, wherein the saturated alicyclic structure-containing thermoplastic polymer is a hydrogenated polymer of tricycle[4.3.0.12,5]deca-3,7-diene, 1,4-metano-1,4,4a,9a-tetrahydrofluorene and tetracyclo[4.4.0.12,5.17,10]-dodeca-3ene.
